(19) United States
(12) Patent Application Publication
(10) Pub. No.: US 2009/0304274 A1
(43) Pub. Date: Dec. 10, 2009

(54) Image Processing Apparatus and Image Display Apparatus

(76) Inventors: Hideki Yoshii, Tokyo (JP); Jun Someya, Tokyo (JP); Shuichi Kagawa, Tokyo (JP); Hiroaki Sugiura, Tokyo (JP)

Correspondence Address: BIRCH STEWART KOLASCH & BIRCH, PO BOX 747, FALLS CHURCH, VA, 22040-0747, US

(21) Appl. No.: 12/086,424

(22) PCT Filed: Dec. 1, 2006
(86) PCT No.: PCT/JP2006/324072

§ 371 Date: Aug. 19, 2009

(30) Foreign Application Priority Data
Dec. 14, 2005 (JP) 2005-359869

(51) Int. Cl. G06K 9/00; H04N 5/66; G09G 5/10

(52) U.S. Cl. 382/167; 348/739; 345/690; 348/E05.133

(57) ABSTRACT

A luminance information detector (3) detects a maximum luminance-signal gradation information value and a minimum luminance-signal gradation information value from one frame of a luminance signal obtained from an image signal (Db) and outputs the values as luminance information values (Yi). A color information detector (20) detects a maximum color-signal gradation information value of the three color signals (RGB) obtained from the image signal (Db) for one frame and a minimum color-signal gradation information value of the three color signals (RGB) obtained from the image signal (Db) for one frame and outputs the values as color information values (Ci). A correction controller (45) calculates parameters (Pa) based on the luminance information value (Yi) and the color information values (Ci); a gradation corrector (5) processes negative color signals point-symmetrically with respect to the origin, according to the parameters (Pa), in the same way as it processes positive color signals. A display unit displays an image based on the image signal (Dc), which is the image signal (Db) after gradation-scale correction. Contrast can thereby be improved without excessive color collapse.

### FIELD OF THE INVENTION

The present invention relates to an image processing apparatus and an image display apparatus.

### BACKGROUND ART

An example of a conventional image display apparatus is disclosed in Patent Document 1. To improve contrast, in the image display apparatus in Patent Document 1, maximum, minimum, and average luminance levels of an image signal are detected, and the luminance levels are amplified up to the dynamic range.

Patent document 1: Japanese Patent No. 3215388

### DISCLOSURE OF THE INVENTION

### Problems to be Solved by the Invention

In general, in image signals representing highly saturated images, there tend to be variations (differences) in the gradation histograms of the three color signals R (red), G (green), and B (blue), and these color signals may include a signal with a gradation value exceeding the maximum gradation level of the luminance signal, or a signal with a gradation value less than the minimum gradation level of the luminance signal. In these cases, during the duration of the component with the large gradation level or the small gradation level, the technology of Patent Document 1 causes a color collapse problem in which gradation differences vanish in one of the color signals.

In addition, the description of the art in patent document 1 does not address negative color signals.

The present invention addresses the above problems with the object of improving contrast in an image signal including negative color signals and providing technology that can improve contrast without causing color collapse.

### Means of Solution of the Problems

In an image processing apparatus for performing image processing on an input image signal including a plurality of color signals, this invention provides an image processing apparatus comprising:

a luminance information detector for detecting, from a luminance signal obtained from the input image signal, for each frame, a maximum luminance signal gradation information value, the maximum luminance signal gradation value being a maximum gradation value or a value equivalent to the maximum gradation value, and a minimum luminance signal gradation information value, the minimum luminance signal gradation information value being a minimum gradation value or a value equivalent to the minimum gradation value, and outputting the detected values as luminance information values;

a correction controller for calculating a correction parameter based on the luminance information values; and

a gradation corrector for performing a gradation-scale correction on the plurality of color signals included in the image signal based on the correction parameter; wherein the plurality of color signals may take negative values.

### EFFECT OF THE INVENTION

By performing a gradation-scale correction on an image signal including negative color signals, based on a maximum gradation information value in the luminance signal or a value equivalent thereto and a minimum gradation information value in the luminance signal or a value equivalent thereto, the above invention can improve contrast even in an image signal including negative color signals.

### BRIEF DESCRIPTION OF THE DRAWINGS

FIG. 1 is a block diagram showing the structure of an image display apparatus according to a first embodiment of the present invention.

FIG. 2 is a block diagram showing the structure of a luminance information detector according to the first embodiment of the present invention.

FIG. 3 shows a histogram generated by the histogram generator according to the first embodiment of the present invention.

FIG. 4 is a graph illustrating an exemplary calculation method of correction parameters by the correction controller in the image display apparatus in the first embodiment of the present invention.

FIG. 5 is a graph illustrating another exemplary calculation method of correction parameters by the correction controller in the image display apparatus in the first embodiment of the present invention.

FIG. 6 is a block diagram showing the structure of a gradation corrector according to the first embodiment of the present invention.

FIG. 7 is a block diagram showing the structure of an image display apparatus according to a second embodiment of the present invention.

FIG. 8 is a block diagram showing the structure of a color information detector according to the second embodiment of the present invention.

FIG. 9 is a histogram generated by the according to the second embodiment of the present invention.

FIG. 10 is a graph illustrating an exemplary calculation method of correction parameters by the correction controller in the image display apparatus in the second embodiment of the present invention.

FIG. 11 is a block diagram showing the structure of a gradation corrector according to the second embodiment of the present invention.

FIGS. 12(a) and 12(b) are graphs illustrating effects produced by the image display apparatus according to the second embodiment of the present invention.

FIG. 13 is a block diagram showing the structure of an exemplary variation of the color information detector according to the second embodiment of the present invention.

FIG. 14 is a block diagram showing the structure of an exemplary variation of the color information detector according to the second embodiment of the present invention.

FIG. 15 is a block diagram showing the structure of the image display apparatus according to a third embodiment of the present invention.

FIG. 16 is a histogram generated by the histogram generator according to the third embodiment of the present invention.

FIG. 17 is a graph illustrating a calculation method of correction parameters by a correction controller in the image display apparatus in the third embodiment of the present invention.

FIG. 18 is a graph illustrating a calculation method of correction parameters by the correction controller in the image display apparatus in the third embodiment of the present invention.

FIGS. 19(a) and 19(b) are graphs illustrating effects produced by the image display apparatus according to the second embodiment of the present invention.

FIG. 20 is a block diagram showing the structure of the image display apparatus according to a fourth embodiment of the present invention.

FIG. 21 is a block diagram showing the structure of a luminance information detector according to the fourth embodiment of the present invention.

### EXPLANATION OF REFERENCE CHARACTERS

1 input terminal, 2 receiver, 3 luminance information detector, 4, 27, 45 correction controller, 5, 28 gradation corrector, 6 display unit, 6a light source, 7, 21, 47 image processing apparatus, YMAX luminance maximum gradation information value, YMIN luminance minimum gradation information value, Yi luminance information values, BMAX, GMAX, RMAX maximum gradation value, BMIN, GMIN, RMIN minimum gradation value, MAX maximum color-signal gradation information value, MIN minimum color-signal gradation information value, Ci color information values, Db, Dc image signal, DbB, DbG, DbR color signal, Hyb, Hyw, HRb, HRw cumulative frequency, YA, YB, RA, RB threshold value

### BEST MODE OF PRACTICING THE INVENTION

### First Embodiment

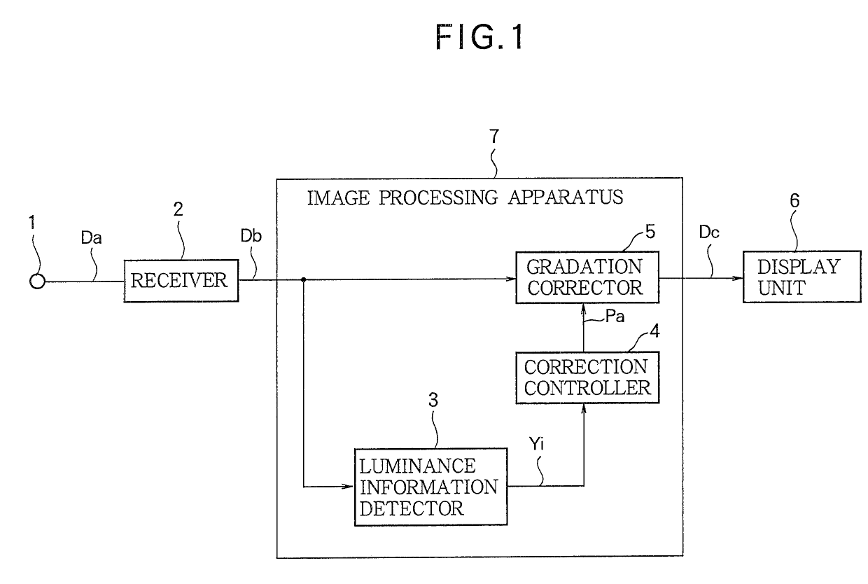

FIG. 1 is a block diagram showing the structure of an image display apparatus according to a first embodiment of the invention. The image display apparatus according to the first embodiment has an input terminal 1, a receiver 2, an image processing apparatus 7, and a display unit 6. An image signal Da having a prescribed format used in television, computers, or the like is input to the input terminal 1. The receiver 2 receives the image signal Da input at the input terminal 1, converts it to a format that can be processed by the image processing apparatus 7, and outputs it as an image signal Db. For example, the receiver 2 converts image signal Da to an image signal in a digital format including three color signals R (red), G (green), and B (blue). If the input image signal Da is an analog signal, the receiver 2 comprises an A/D converter or the like; if the input image signal Da is a digital signal, the receiver 2 comprises a demodulator or the like that converts the signal to a suitable format.

The image processing apparatus 7 comprises a luminance information detector 3, a correction controller 4, and a gradation corrector 5. The image signal Db output from the receiver 2 is input to the luminance information detector 3 and gradation corrector 5 in the image processing apparatus 7. The luminance information detector 3 detects luminance information values Yi by calculating luminance signal values from the three color signals (RGB) included in the input image signal Db and outputs the detected information value to the correction controller 4. The correction controller 4 derives correction parameters Pa used by the gradation corrector 5 in performing gradation-scale corrections on the image signal Db from the luminance information values Yi, and outputs them to the gradation corrector 5.

The gradation corrector 5 uses the input correction parameters Pa to perform a gradation-scale correction on the image signal Db, which it then outputs as an image signal Dc to the display unit 6. Any type of display means, such as a reflective, transmissive, or self-emissive device, may be used as the display unit 6, which may be, for example, a liquid crystal display, a DMD (Digital Micromirror Device) display, an EL (electro-luminescence) display, or a plasma display.

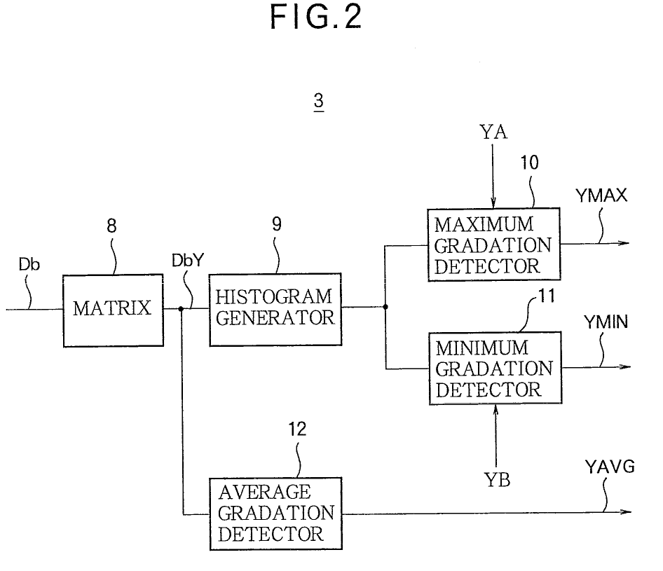

FIG. 2 is a block diagram showing the detailed structure of the luminance information detector 3. As shown in FIG. 2, the luminance information detector 3 comprises a matrix circuit 8, a histogram generator 9, a maximum gradation detector 10, a minimum gradation detector 11, and an average gradation detector 12.

Color signals DbR, DbG, DbR representing the red, green, and blue components in the image data Db input from the receiver 2 are input to the matrix circuit 8. The matrix circuit calculates a luminance signal DbY from these inputs DbR, DbG, DbB according to the following equation, and outputs the calculated luminance signal DbY to the histogram generator 9 and the average gradation detector 12.

DbY=0.30×DbR+0.59×DbG+0.11×DbB (1)

Depending on the form of an input signal, another equation or other coefficients may be used to calculate the luminance signal DbY; for simplicity, a simpler equation may be used.

The histogram generator 9 generates a gradation histogram of the luminance signal DbY for one frame. The maximum gradation detector 10 detects the maximum luminance gradation information value YMAX for one frame from the histogram generated by the histogram generator 9 and outputs the detected value. The minimum gradation detector 11 detects the minimum luminance gradation information value YMIN for one frame from the histogram generated by the histogram generator 9 and outputs the detected value. The average gradation detector 12 calculates the average gradation value in the luminance signal DbY for one frame and outputs the value as a luminance average gradation information value YAVG.

The maximum gradation information value herein means the maximum gradation value or a value that is detected by a prescribed method, which will be described later, and is equivalent to the maximum gradation value. The minimum gradation information value herein means the minimum gradation value or a value that is detected by a prescribed method, which will be described later, and is equivalent to the minimum gradation value.

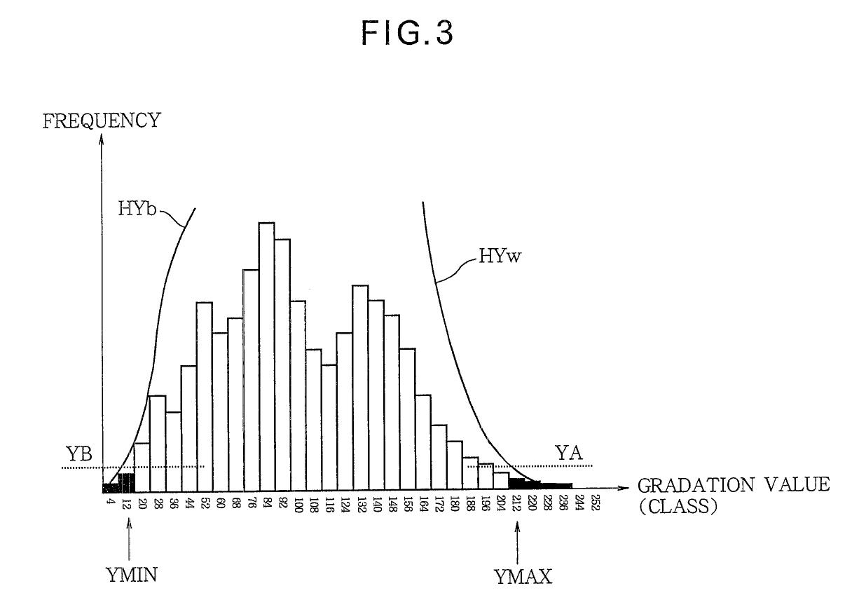

FIG. 3 shows an exemplary histogram generated by the histogram generator 9. The horizontal axis in the drawing indicates gradation values (representing classes); the vertical axis indicates frequencies, which are pixel counts within one frame of the luminance signal DbY. In the description that follows, the luminance signal DbY comprises eight-bit data, so its gradation values range from ‘0’ to ‘255’ and the number of gradations is ‘256’.

The histogram generator 9 in the first embodiment divides the 256 gradations into 32 regions at intervals of eight gradations, and uses the 32 regions as the classes in the histogram. A value near the central value of each class, in this example the nearest integer value larger than the central value, is used as a representative value of the class. For example, since ‘3.5’ is the central value of the class consisting of gradation values from ‘0’ to ‘7’, the representative value of this class is ‘4’. The numbers on the horizontal axis in FIG. 3 indicate the representative value of each class.

If the central value of a class is an integer, the central value may be used as the representative value of the class. If the central value of the class is not an integer and has a fractional part, as in the present example, the central value may still be used as the representative value of the class. If an integer close to the central value of the class is used as the representative value of the class when the central value has a fractional part, as in the present example, the amount of computation can be reduced.

In the histogram generator 9 according to the first embodiment, one region comprising eight consecutive gradation values is treated as one class, as described above, so that each frequency in the histogram shown in FIG. 3 is a total frequency of signals having eight gradations. For example, the frequency corresponding to the value ‘4’ on the horizontal axis is the total frequency of signals with gradation values from ‘0’ to ‘7’ in the luminance signal DbY for one frame.

The histogram may be generated by counting the frequency of each gradation value. That is, differing from the histogram shown in FIG. 3, each class may include only one gradation value. In that case, the gradation value constituting the class naturally becomes the representative value of the class. When the gradations are divided into classes, the number of classes need not be 32; the number of classes may be reduced to reduce the amount of computation in the histogram generator 9. The number of classes should be determined on the basis of the amount of computation that can be performed and the gradation-scale correction precision required by the gradation corrector 5.

The maximum gradation detector 10 accumulates the frequencies in the histogram generated as above from the maximum toward the minimum class, and extracts the representative value of the class at which the cumulative frequency HYw thus obtained first exceeds a predetermined threshold value YA. The maximum gradation detector 10 outputs the extracted representative value as the maximum luminance gradation information value YMAX.

The minimum gradation detector 11 accumulates the frequencies in the histogram generated by the histogram generator 9 from the minimum toward the maximum class, and extracts the representative value of the class at which the cumulative frequency HYb thus obtained first exceeds a predetermined threshold value YB. The minimum gradation detector 11 outputs the extracted representative value as the minimum gradation information value YMIN.

In the histogram shown in FIG. 3, the representative value of the class at which cumulative frequency HYw first exceeds threshold value YA is ‘212’. This value of ‘212’ becomes the maximum luminance gradation information value YMAX. This maximum luminance gradation information value YMAX is not the maximum gradation value in the color signal DbR for one frame but a value detected as being equivalent to the maximum gradation value, by using the cumulative frequency HYw and threshold value YA.

In the example shown in FIG. 3, the representative value of the class at which cumulative frequency HYb first exceeds threshold value YB is ‘12’. This value of ‘12’ becomes the minimum luminance gradation information value YMIN. This minimum luminance gradation information value YMIN is not the minimum gradation value in the color signal DbY for one frame but a value detected as being equivalent to the minimum gradation value, by using the cumulative frequency Hyb and threshold value YB.

The representative value of the largest of the classes in which frequencies were counted may be output as the maximum luminance gradation information value YMAX, without calculating the cumulative frequency HYw. In that case, if a histogram in which each class comprises one gradation value is used, the maximum luminance gradation information value YMAX is the maximum gradation value in the color signal DbY for one frame; if a histogram in which each class comprises a plurality of gradation values is used, the maximum luminance gradation information value YMAX is a value equivalent to the maximum gradation value in the color signal DbR for one frame. In the example shown in FIG. 3, the gradation value ‘236’ would be the maximum luminance gradation information value YMAX.

The representative value of the smallest of the classes in which frequencies were counted may be output as the minimum luminance gradation information value YMIN, without calculating the cumulative frequency HYb. In that case, if a histogram in which each class comprises one gradation value is used, the minimum luminance gradation information value YMIN is the minimum gradation value in the color signal DbY for one frame; if a histogram in which each class comprises a plurality of gradation values is used, the minimum luminance gradation information value YMIN is a value equivalent to the minimum gradation value in the color signal DbY for one frame. In the example shown in FIG. 3, the gradation value ‘4’ would be the minimum luminance gradation information value YMIN.

The value equivalent to the maximum gradation value in the luminance signal DbY obtained from one frame of the image signal Db may thus be detected using the cumulative frequency HYw and threshold value YA, or in a histogram in which each class comprises a plurality of gradation values, the representative value of the highest of the classes in which frequencies were counted may be used. Similarly, the value equivalent to the minimum gradation value in the luminance signal DbY obtained from one frame of the image signal Db may be detected using the cumulative frequency HYb and threshold value YB, or in a histogram in which each class comprises a plurality of gradation values, the representative value of the lowest of the classes in which frequencies were counted may be used.

The value equivalent to the maximum gradation value may happen to coincide with the maximum gradation value, and the value equivalent to the minimum gradation value may happen to coincide with the minimum gradation value.

In this example, cumulative frequencies HYw and HYb are generated by the histogram generator 9, but they may be generated by the maximum gradation detector 10 and the minimum gradation detector 11=

The maximum luminance gradation information value YMAX, the minimum luminance gradation information value YMIN, and the luminance average gradation YAVG are output as the luminance information values Yi from the luminance information detector 3 to the correction controller 4.

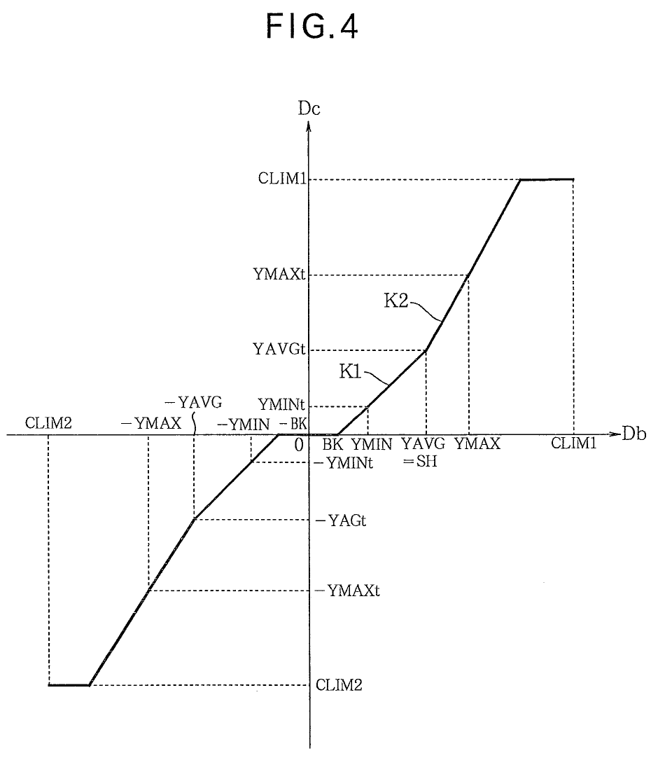

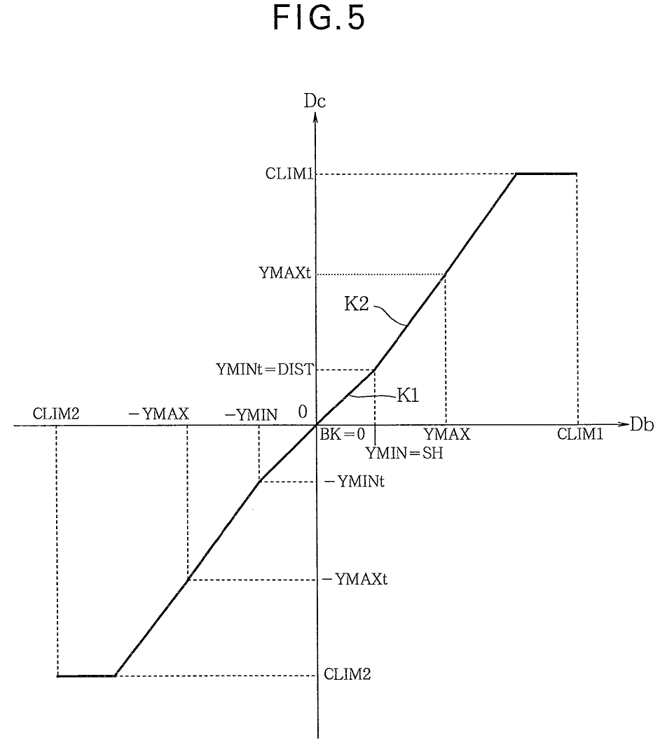

The correction controller 4 calculates correction parameters Pa based on the input luminance information values Yi and outputs the result to the gradation corrector 5. The correction parameters Pa are a set of parameters K1, K2, BK, SH, and DIST, for example, which will be described below. FIGS. 4 and 5 are graphs illustrating different exemplary methods of calculating correction parameters Pa in the correction controller 4.

In the example shown in FIG. 4, in the x-y coordinate system, in which both the horizontal axis (x-axis) and the vertical axis (y-axis) indicate gradation values, the maximum luminance gradation information value YMAX, the minimum luminance gradation information value YMIN, and the luminance average gradation YAVG in the luminance information value Yi, are indicated on the x-axis; the respective target values YMAXt, YMINt, and YAVGt when gradation corrections are performed with the maximum luminance gradation information value YMAX, the minimum luminance gradation information value YMIN, and the luminance average gradation YAVG are indicated on the y-axis.

The correction controller 4 considers a straight line drawn connecting x-y coordinates (YAVG, YAVGt) and x-y coordinates (YMIN, YMINt) and a straight line drawn connecting x-y coordinates (YMAX, YMAXt) and x-y coordinates (YVAG, YAVGt) and obtains the values of the slope K1 of the former straight line, the slope K2 of the latter straight line, and the point BK at which the straight line with the slope K1 intersects the x-axis as parameters K1, K2, and BK, respectively, from the following equations (2), (3), and (4).

K1=(YAVGt−YMINt)/(YAVG−YMIN) (2)

K2=(YMAXt−YAVGt)/(YMAX−YAVG) (3)

BK=YMIN−YMINt/K1 (4)

As shown in the drawings, SH and DIST are expressed as follows:

SH=YAVG (5)

DIST=YAVGt (6)

At this time, as shown in the drawings, the same effect can be obtained on negative color signals by performing the same processing on the negative color signals as on the positive color signals to which they are point symmetric with respect to the origin.

In this case, the upper limit of each of the color signals R, G, B is indicated as CLIM1, and the lower limit is indicated as CLIM2 (a negative value) in FIG. 4. The parameters Pa calculated from the maximum luminance gradation information value YMAX, the minimum luminance gradation information value YMIN, and the luminance average gradation YAVG can be used to perform the gradation-scale correction of color signals within the range from the upper limit value CLIM1 to the lower limit value CLIM2, or the symmetrical negative value, of each of the color signals R, G, and B.

If the gradation-scale correction is performed using the two slopes K1 and K2 in this way, target values can be set for the three luminance information values, the minimum luminance gradation information value YMIN, the maximum luminance gradation information value YMAX, and the luminance average gradation YAVG, which improves contrast and enables conversion to an arbitrary gradation characteristic.

In the example shown in FIG. 5, in the x-y coordinate system, in which both the horizontal axis (x-axis) and the vertical axis (y-axis) indicate gradation values, the maximum luminance gradation information value YMAX, the minimum luminance gradation information value YNIN, and the luminance average gradation YAVG in the luminance information values Yi are indicated on the x-axis; the respective target values YMAXt, YMINt, and YAVGt when gradation corrections are performed with the maximum luminance gradation information value YMAX, the minimum luminance gradation information value YNIN, and the luminance average gradation YAVG are indicated on the y-axis.

The correction controller 4 considers a straight line drawn connecting x-y coordinates (YAVG, YAVGt) and x-y coordinates (YNIN, YNINt) and a straight line drawn connecting x-y coordinates (YMAX, YMAXt) and x-y coordinates (YVAG, YAVGt), and obtains the values of the slope K1 of the former straight line, the slope K2 of the latter straight line, and the point BK at which the straight line with the slope K1 intersects the x-axis as parameters K1, K2, and BK respectively, from the following equations (7), (8), and (9).

K1=(YMINt)/(YMIN) (7)

K2=(YMAXt−YMINt)/(YMAX−YMIN) (8)

BK=0 (9)

As shown in the drawings, SH and DIST are expressed as follows:

SH=YAVG (10)

DIST=YAVGt (11)

Holding BK at zero (BK=0) as above during the gradation correction results in less gradation variation in dark-colored image areas, to which the human eye is sensitive, and less image flicker due to time-varying gradation correction characteristics.

If YMINt equals YMIN (YMINt=YMIN), K1 is held at 1 (K1=1); since no gradation-scale correction is performed for image areas with luminance less than YMIN, gradation skip, gradation collapse, and other picture defects can also be made less visible to the human eye.

Then the correction controller 4 outputs the obtained parameters K1, K2, BK, SH, and DIST as the correction parameters Pa to the gradation corrector 5.

Based on the correction parameters Pa, the gradation corrector 5 corrects the gradation values of the image signal Db for the one frame which has been used to obtain the correction parameters Pa. The gradation-scale correction may be performed in each frame or once in several frames (two to nine frames), or may be performed on the image signal delayed one frame to several frames (two to nine frames) from the image signal Db for the one frame which has been used to obtain the correction parameters Pa, in accordance with the correction parameters Pa.

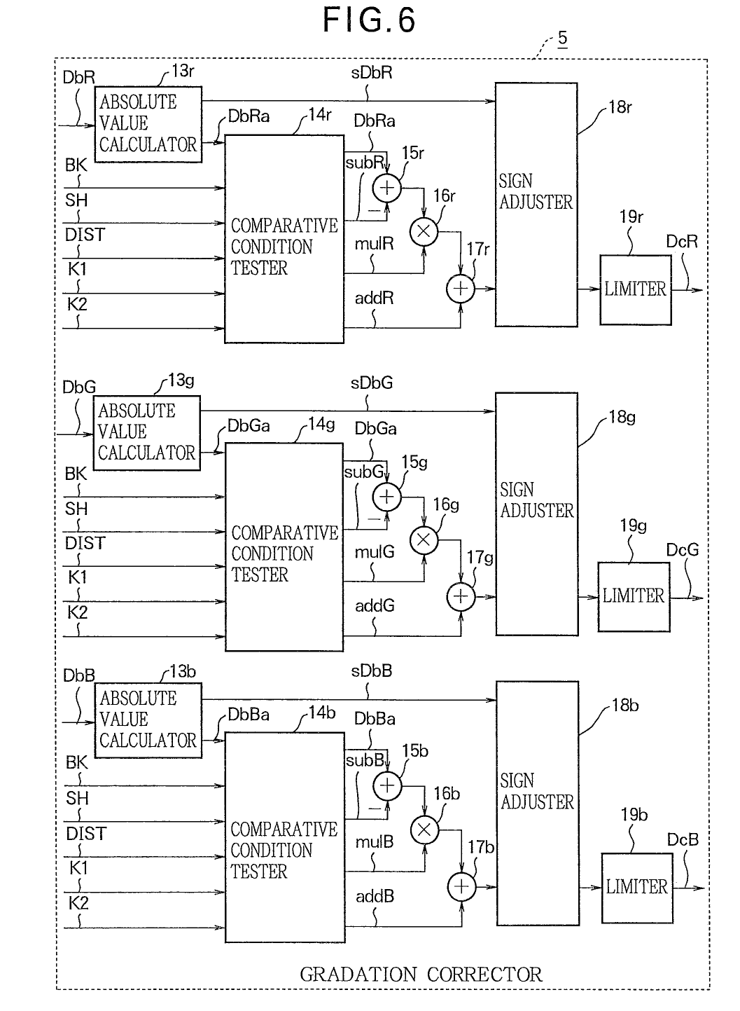

FIG. 6 is a block diagram showing the detailed structure of a gradation corrector 5 that performs the gradation-scale correction using the parameters K1, K2, BK, SH, and DIST. As shown in FIG. 6, the gradation corrector 5 comprises absolute value calculators 13r, 13g, 13b, comparative condition testers 14r, 14g, 14b, subtractors 15r, 15g, 15b, multipliers 16r, 16g, 16b, adders 17r, 17g, 17b, sign adjusters 18r, 18g, 18b, and limiters 19r, 19g, 19b.

The absolute value calculators 13r, 13g, 13b receive color signal DbR, DbG, DbB, respectively. The absolute value calculators 13r, 13g, 13b output sign signals sDbR, sDbG, sDbB to the sign adjusters 18r, 18g, 18b in accordance with the signs of the color signals DbR, DbG, DbB, calculate the absolute values of the color signals DbR, DbG, DbB, and output the results as absolute value signals DbRa, DbGa, DbBa to the comparative condition testers 14r, 14g, 14b. The comparative condition testers 14r, 14g, 14b each receive the parameters K1, K2 BK. SH, and DIST.

Comparative condition tester 14r outputs the received absolute signal DbRa to subtractor 15r without change. Comparative condition tester 14r also uses the parameter SH as a threshold value, compares the gradation value of the absolute value signal DbRa with the parameter SH for each pixel, and if the gradation value of the absolute value signal DbRa is smaller than the parameter SH, outputs the parameter BK as a value subR to subtractor 15r, the parameter K1 as a value mulR to multiplier 16r, and ‘0’ as a value addR to adder 17r.

If the gradation value of the absolute value signal DbRa is greater than or equal to the parameter SH, comparative condition tester 14r outputs parameter SH as the subR value to subtractor 15r, parameter K2 as the mulR value to multiplier 16r, and parameter DIST as the addR value to adder 17r.

If BK is not 0 as in FIG. 4, the comparative condition tester 14r compares the gradation value of the absolute value signal DbRa with the parameter BK for each pixel, and if the gradation value of the absolute value signal DbRa is smaller than parameter BK, outputs ‘0’ as the subR value to subtractor 15r, ‘0’ as the mulR value to multiplier 16r, and ‘0’ as the addR value to adder 17r.

Subtractor 15r subtracts the value subR from the gradation value of the absolute value signal DbRa and outputs the resulting difference to multiplier 16r. Multiplier 16r multiplies the input difference by the mulR value and outputs the resulting product to adder 17r Adder 17r adds the input product to the addR value and outputs the resulting sum to sign adjuster 18r. If the sign signal sDbR indicates a positive sign, sign adjuster 18r outputs the sum received from adder 17r as is; if the sign signal sDbR indicates a negative sign, sign adjuster 18r converts the sum received from adder 17r to a negative value and outputs it to limiter 19r. If the value output from the sign adjuster 18r exceeds the specifiable range (dynamic range) of gradation values, limiter 19r limits the output value from the sign adjuster 18r and outputs the limited value as the DcR color signal.

Similarly, comparative condition tester 14g outputs the DbGa absolute value signal to subtractor 15g and, if the gradation value of the DbB absolute value signal is smaller than the parameter SH, outputs the parameter BK as a value subG to subtractor 15g, the parameter K1 as a value mulG to multiplier 16g, and ‘0’ as a value addG to adder 17g. If the gradation value of the DbGa absolute value signal is greater than or equal to the parameter SH, comparative condition tester 14g outputs the parameter SH as the subG value to subtractor 15g, outputs the parameter K2 as the mulG value to multiplier 16g, and outputs the parameter DIST as a value addG to adder 17g.

If BK is not 0 as shown in FIG. 4, comparative condition tester 14g compares the gradation value of the DbGa absolute value signal with the parameter BK for each pixel, and if the gradation value of the DbGa absolute value signal is smaller than parameter BK, outputs ‘0’ as the subG value to subtractor 15g, ‘0’ as the mulG value to multiplier 16g, and ‘0’ as the addG value to adder 17g.

Subtractor 15g subtracts the subG value from the gradation value of the DbGa absolute value signal, multiplier 16g multiplies the resulting difference obtained in subtractor 15g by the mulG value, and adder 17g adds the resulting product input from multiplier 16g to the addG value. If the sign signal sDbG indicates a positive sign, sign adjuster 18g outputs the sum obtained in adder 17g as is; if the sign signal sDbG indicates a negative value, sign adjuster 18g converts the sum obtained in adder 17g to a negative value and outputs it to limiter 19g. If the value output from sign adjuster 18g exceeds the specifiable range of gradation values, limiter 19g limits the value output from sign adjuster 18g to the specifiable range and outputs the limited value as the DcG color signal.

Similarly, comparative condition tester 14b outputs the DbBa absolute value signal to subtractor 15b and, if the gradation value of the DbBa absolute value signal is smaller than the parameter SH, outputs the parameter BK as a value subB to subtractor 15b, the parameter K1 as a value mulB to multiplier 16b, and ‘0’ as a value addB to adder 17b. If the gradation value of the DbBa absolute value signal is greater than or equal to the parameter SH, comparative condition tester 14b outputs the parameter SH as the subB value to subtractor 15b, outputs the parameter K2 as the mulB value to multiplier 16b, and outputs the parameter DIST as a value addB to adder 17b.

If BK is not 0 as shown in FIG. 4, comparative condition tester 14b compares the gradation value of the DbBa absolute value signal with the parameter BK for each pixel, and if the gradation value of the DbBa absolute value signal is smaller than parameter BK, outputs ‘0’ as the subB value to subtractor 15b, ‘0’ as the mulB value to multiplier 16b, and ‘0’ as the addG value to adder 17b.

Subtractor 15b subtracts the subB value from the gradation value of the DbBa absolute value signal, multiplier 16b multiplies the resulting difference input from subtractor 15b by the mulB value, and adder 17b adds the product obtained in multiplier 16b to the addB value. If the sign signal sDbB indicates a positive sign, sign adjuster 18b outputs the sum obtained in adder 17b as is; if the sign signal sDbB indicates a negative sign, sign adjuster 18b converts the sum obtained in adder 17b to a negative value and outputs it to limiter 19b. If the value output from sign adjuster 18b exceeds the specifiable range of gradation values, limiter 19b limits the value output from sign adjuster 18b to the specifiable range and outputs the limited value as the DcB color signal.

Let the gradation value of each color signal before gradation-scale correction be A0 and the gradation value after gradation-scale correction be A1. In the gradation corrector 6 structured as described above, if (absolute value of A0)<SH, then A1=(sign of A0)(absolute value of A0−BK)×K1, and if (absolute value of A0)≧SH, then A1=(sign of A0)((absolute value of A0)−SH)×K2+DIST. If the upper limit of the specifiable range of gradation values is ‘CLIM1’, then when (sign of A0)((absolute value of A0)−BK)×K1>CLIM1 or (sign of A0)((absolute value of A0)−SH)×K2+DIST >CLIM1, A1 is limited to ‘CLIM1’. If the lower limit of the specifiable range of gradation values is ‘CLIM2’, then when (sign of A0)((absolute value of A0)−BK)×K1 <CLIM2 or (sign of A0)((absolute value of A0)−SH)×K2+DIST<CLIM2, A1 is limited to ‘CLIM2’.

The parameters Pa calculated from the luminance information Yi detected in the luminance signal DbY are used to perform gradation corrections point-symmetrically on both positive and negative color signals as shown in FIGS. 4 and 5, whereby the size of the circuit can be kept small while the same effects can be obtained on negative color signals as on positive color signals.

As described above, the image processing apparatus of the first embodiment performs gradation corrections on an image signal including negative color signals, based on the maximum luminance gradation value or a value equivalent to the maximum luminance gradation value and the minimum luminance gradation value or a value equivalent to the minimum luminance gradation value, thereby improving contrast for an image signal including negative color signals.

### Second Embodiment

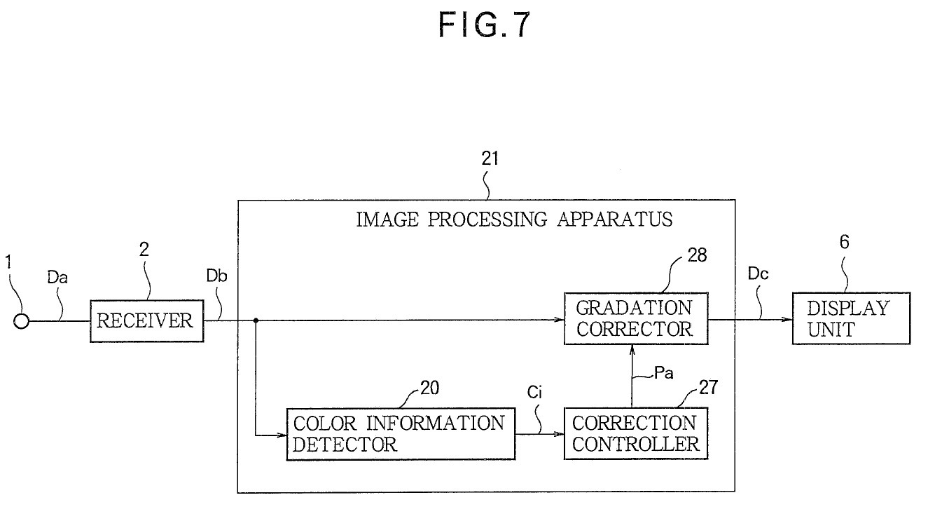

FIG. 7 is a block diagram showing the structure of an image display apparatus according to a second embodiment of the invention. The image display apparatus according to the second embodiment has an image processing apparatus 21 instead of the image processing apparatus 7 in the image processing apparatus according to the first embodiment described above.

The image processing apparatus 21 according to the second embodiment comprises a color information detector 20, a correction controller 27, and a gradation corrector 28. The image signal Db output from the receiver 2 is input to the color information detector 20 and the gradation corrector 28 in the image processing apparatus 21. The color information detector 20 detects color information values Ci from the three color signals (RGB) included in the input image signal Db and outputs it to the correction controller 27. The correction controller 27 derives correction parameters Pa used by the gradation corrector 28 in performing gradation-scale corrections on the image signal Db from the color information values Ci, and outputs them to the gradation corrector 28.

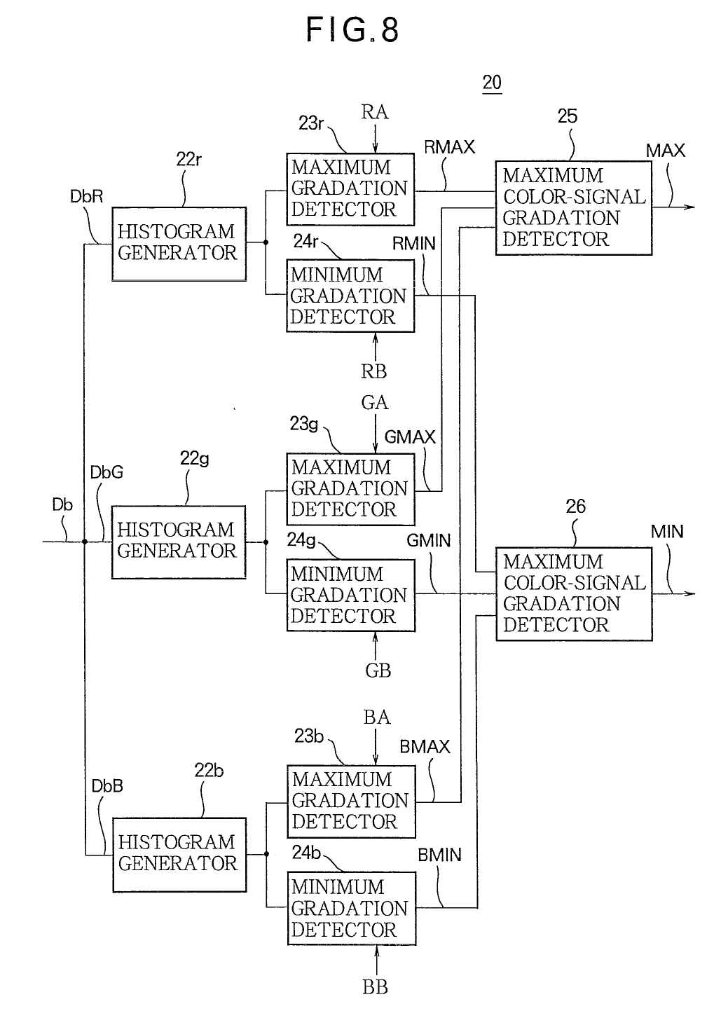

FIG. 8 is a block diagram showing the detailed structure of the color information detector 20. As shown in FIG. 8, the color information detector 20 comprises histogram generators 22r, 22g, 22b, maximum gradation detectors 23r, 23g, 23b, minimum gradation detectors 24r, 24g, 24b, a maximum color-signal gradation detector 25, and a minimum color-signal gradation detector 26.

A red color signal DbR, a green color signal DbG, and a blue color signal DbB are input to the histogram generators 22r, 22g, and 22b, respectively.

The histogram generator 22r generates a gradation histogram of the color signal DbR for one frame. Maximum gradation detector 23r detects the maximum gradation information value RMAX in the color signal DbR for one frame from the histogram generated by the histogram generator 22r and outputs the detected value to the maximum color-signal gradation detector 25. Minimum gradation detector 24r detects the minimum gradation information value RMIN for one frame from the histogram generated by the histogram generator 22r and outputs the detected value to the minimum color-signal gradation detector 26.

The maximum gradation information value herein means the maximum gradation value or a value that is detected by a prescribed method, which will be described later, and is equivalent to the maximum gradation value. The minimum gradation information value herein means the minimum gradation value or a value that is detected by a prescribed method, which will be described later, and is equivalent to the minimum gradation value.

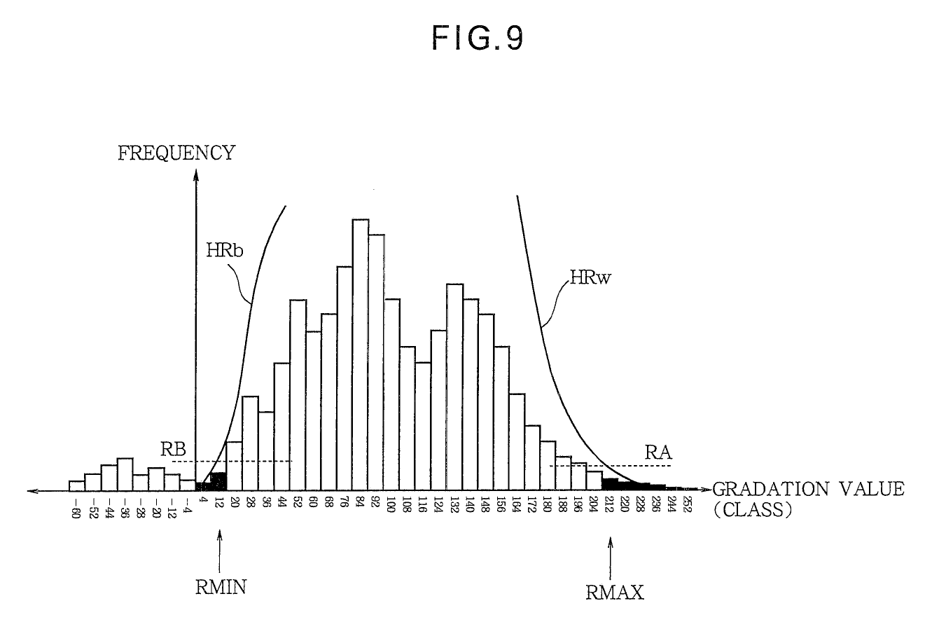

FIG. 9 shows an exemplary histogram generated by the histogram generator 22r. The horizontal axis in the drawing indicates gradation values (representing classes); the vertical axis indicates frequencies, which are pixel counts within one frame of the color signal DbR. In the description that follows, the color signal DbR comprises eight-bit data, so its gradation values range from ‘0’ to ‘255’ and the number of gradations is ‘256’.

The histogram generator 22r in the second embodiment divides the 256 gradations into 32 regions at intervals of eight gradations, and uses the 32 regions as the classes in the histogram. A value near the central value of each class, in this example the nearest integer value larger than the central value, is used as a representative value of the class. For example, since ‘3.5’ is the central value of the class consisting of gradation values from ‘0’to ‘7’, the representative value of this class is ‘4’. The numbers on the horizontal axis in FIG. 9 indicate the representative value of each class.

If the central value of a class is an integer, the central value may be used as the representative value of the class. If the central value of the class is not an integer and has a fractional part, as in the present example, the central value may still be used as the representative value of the class. If an integer close to the central value of the class is used as the representative value of the class when the central value has a fractional part, as in the present example, the amount of computation can be reduced.

In the histogram generator 22r according to the second embodiment, one region comprising eight consecutive gradation values is treated as one class, as described above, so that each frequency in the histogram shown in FIG. 9 is a total frequency of signals having eight gradations. For example, the frequency corresponding to the value ‘4’ on the horizontal axis is the total frequency of signals with gradation values from ‘0’to ‘7’ in the color signal DbR for one frame.

The histogram may be generated by counting the frequency of each gradation value. That is, differing from the histogram shown in FIG. 9, each class may include only one gradation value. In that case, the gradation value constituting the class naturally becomes the representative value of the class. When the gradations are divided into classes, the number of classes need not be 32; the number of classes may be reduced to reduce the amount of computation in the histogram generator 22r. The number of classes should be determined on the basis of the amount of computation that can be performed and the gradation-scale correction precision required by the gradation corrector 5.

Maximum gradation detector 23r accumulates the frequencies in the histogram generated as above from the maximum toward the minimum class, and extracts the representative value of the class at which the cumulative frequency HRw thus obtained first exceeds a predetermined threshold value RA. Maximum gradation detector 23r outputs the extracted representative value as the maximum gradation information value RMAX.

Minimum gradation detector 24r accumulates the frequencies in the histogram generated by the histogram generator 22r from the minimum toward the maximum class, and extracts the representative value of the class at which the cumulative frequency HRb thus obtained first exceeds a predetermined threshold value RB. Minimum gradation detector 24r outputs the extracted representative value as the minimum gradation information value RMIN.

Although FIG. 9 shows negative gradation values, the negative gradation values Are ignored in the second embodiment, and the minimum value of the positive gradation values is obtained.

In the histogram shown in FIG. 9, the representative value of the class at which cumulative frequency HRw first exceeds threshold value RA is ‘212’. This value of ‘212’ becomes the maximum gradation information value RMAX. This maximum gradation information value RMAX is not the maximum gradation value in the color signal DbR for one frame but a value detected as being equivalent to the maximum gradation value, by using the cumulative frequency HRw and threshold value RA.

In the example shown in FIG. 9, the representative value of the class at which cumulative frequency HRb first exceeds threshold value YB in the positive range is ‘12’. This value of ‘12’ becomes the minimum gradation information value RMIN. This minimum gradation information value RMIN is not the minimum gradation value in the color signal DbR for one frame but a value detected as being equivalent to the minimum gradation value, by using the cumulative frequency HRb and threshold value RB.

The representative value of the largest of the classes in which frequencies were counted may be output as the maximum gradation information value RMAX, without calculating the cumulative frequency HRw. In that case, if a histogram in which each class comprises one gradation value is used, the maximum gradation information value RMAX is the maximum gradation value in the color signal DbR for one frame; if a histogram in which each class comprises a plurality of gradation values is used, the maximum gradation information value RMAX is a value equivalent to the maximum gradation value in the color signal DbR for one frame. In the example shown in FIG. 9, the gradation value ‘236’ would be the maximum gradation information value RMAX.

The representative value of the smallest of the classes in which frequencies were counted may be output as the minimum gradation information value RMIN, without calculating the cumulative frequency HRb. In that case, if a histogram in which each class comprises one gradation value is used, the minimum gradation information value RMIN is the minimum gradation value in the color signal DbR for one frame; if a histogram in which each class comprises a plurality of gradation values is used, the minimum gradation information value RMIN is a value equivalent to the minimum gradation value in the color signal DbR for one frame. In the example shown in FIG. 9, the gradation value ‘4’ would be the minimum gradation information value RMIN.

The value equivalent to the maximum gradation value in the color signal DbR obtained from one frame of the image signal Db may thus be detected using the cumulative frequency HRw and threshold value RA, or in a histogram in which each class comprises a plurality of gradation values, the representative value of the highest of the classes in which frequencies were counted may be used. Similarly, the value equivalent to the minimum gradation value in the color signal DbR obtained from one frame of the image signal Db may be detected using the cumulative frequency HRb and threshold value RB, or in a histogram in which each class comprises a plurality of gradation values, the representative value of the lowest of the classes in which frequencies were counted may be used.

The value equivalent to the maximum gradation value may happen to coincide with the maximum gradation value, and the value equivalent to the minimum gradation value may happen to coincide with the minimum gradation value.

The color signals DbG and DbB are processed in the same way as the color signal DbR. The histogram generator 22g generates a gradation histogram of the color signal DbG for one frame Maximum gradation detector 23g detects the maximum gradation information value GMAX in the color signal DbG for one frame from the histogram and outputs the detected value to the maximum color-signal gradation detector 25. Minimum gradation detector 24g detects the minimum gradation information value GMIN for one frame from the histogram and outputs the detected value to the minimum color-signal gradation detector 26. Similarly, histogram generator 22b generates a gradation histogram of the color signal DbB for one frame. Maximum gradation detector 23b detects the maximum gradation information value GMAX in the color signal DbG for one frame from the histogram and outputs the detected value to the maximum color-signal gradation detector 25. Minimum gradation detector 24b detects the minimum gradation information value BMIN for one frame from the histogram and outputs the detected value to the minimum color-signal gradation detector 26.

The maximum color-signal gradation detector 25 detects the maximum gradation information value in the color signals DbR, DbG, and DbB for one frame from the maximum gradation information values RMAX, GMAX, and BMAX, and outputs it as the maximum color-signal gradation information value MAX. More specifically, the maximum color-signal gradation detector 25 outputs the largest of the maximum gradation information values RMAX, GMAX, and BMAX as the maximum color-signal gradation information value MAX.

The minimum color-signal gradation detector 26 detects the minimum gradation information value in the color signals DbR, DbG, and DbB for one frame from the minimum gradation information values RMIN, GMIN, and BMIN, and outputs it as the minimum color-signal gradation information value MIN. The maximum color-signal gradation information value MAX and the minimum color-signal gradation value MIN are input to the correction controller 27 as color information values Ci.

When each of the maximum gradation information values RMAX, GMAX, BMAX is the maximum gradation value in a single color signal for one frame, the maximum color-signal gradation information value MAX is the maximum gradation value in the entire collection of color signals DbR, DbG, DbB; when each of the maximum gradation information values RMAX, GMAX, BMAX is a value equivalent to the maximum gradation value in a single color signal for one frame, the maximum color-signal gradation information value MAX is a value equivalent to the maximum gradation value in the entire collection of color signals DbR, DbG, DbB.

Similarly, when each of the minimum gradation information values RMIN, GMIN, BMIN is the minimum gradation value in a single color signal for one frame, the minimum color-signal gradation information value MIN is the minimum gradation value in the entire collection of color signals DbR, DbG, DbB; when each of the minimum gradation information values RMIN, GMIN, BMIN is a value equivalent to the minimum gradation value in a single color signal for one frame, the minimum color-signal gradation information value MIN is a value equivalent to the minimum gradation value in the entire collection of color signals DbR, DbG, DbB.

In this example, cumulative frequencies HRw and HRb are generated by the histogram generators 22r, 22g, and 22b, but they may be generated by the maximum gradation detectors 23r, 23g, and 23b, and the minimum gradation detectors 24r, 24g, and 24b.

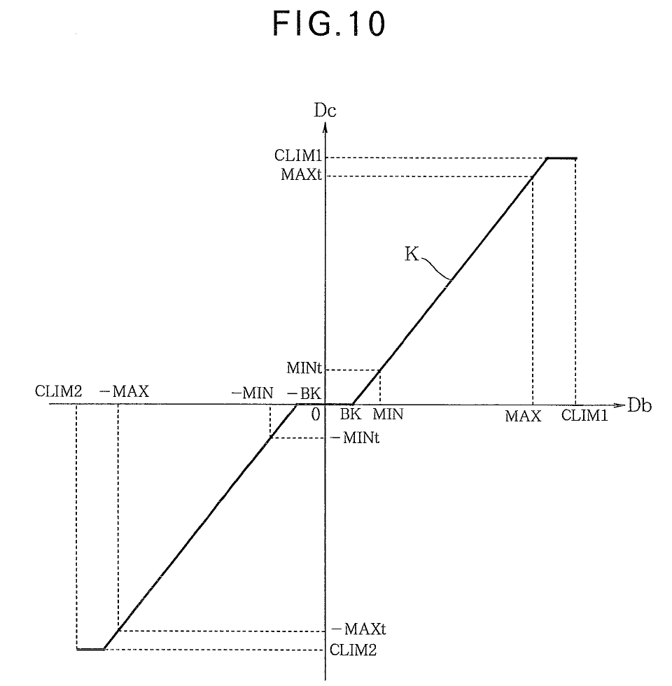

The correction controller 27 calculates correction parameters Pa based on the input color signal information values Ci and outputs the result to the gradation corrector 28. The correction parameters Pa are a set of parameters K1, K2, BK, SH, and DIST, for example, which will be described below. FIG. 10 is a graph illustrating the method of calculating correction parameters Pa in the correction controller 27. In FIG. 10, in the x-y coordinate system, in which both the horizontal axis (x-axis) and the vertical axis (y-axis) indicate gradation values, the maximum color-signal gradation information value MAX and the minimum color-signal gradation information value MIN in the color signal information values Ci are indicated on the x-axis; the respective target values MAXt and MINt when gradation corrections are performed with the maximum color-signal gradation information value MAX and the minimum color-signal gradation information value MIN are indicated on the y-axis. The correction controller 27 considers a straight line drawn connecting x-y coordinates (MAX, MAXt) and x-y coordinates (MIN, MINt) and obtains the values of the slope K of the former straight line and the point BK at which the straight line with the slope K intersects the x-axis as parameters K and BK from the following equations (12) and (13).

K=(MAXt−MINt)/(MAX−MIN) (12)

BK=MIN−MINt/K1 (13)

The correction controller 27 outputs the obtained parameters K and BK to the gradation corrector 28 as correction parameters Pa.

The target values MAXt and MINt can easily be obtained in the correction controller 27 from the following equations (14) and (15).

MAXt=MAX+(MAX−MIN)×Kmax (14)

MINt=MIN−(MAX−MIN)×Kmin (15)

In the above, Kmax and Kmin should be values from 0 to 1; setting too large a value can create too much contrast, resulting in an unsightly image.

Since the target values MAXt and MINt cannot be set to values beyond the upper and lower limits of the specifiable gradation value range (dynamic range), MAXt is set to a value that is equal to or less than CLIM1 (MAXt ≦CLIM1), where CLIM1 indicates a positive upper limit. MINt is set to a value equal to or greater than zero (MINt≧0).

Based on the correction parameters Pa, the gradation corrector 28 corrects the gradation values of the image signal Db for the one frame which has been used to obtain the correction parameters Pa. The gradation-scale correction may be performed in accordance with the correction parameters Pa in each frame or once in several frames (two to nine frames), or may be performed on the image signal delayed by one frame to several frames (two to nine frames) from the one frame of the image signal Db from which the correction parameters Pa were obtained.

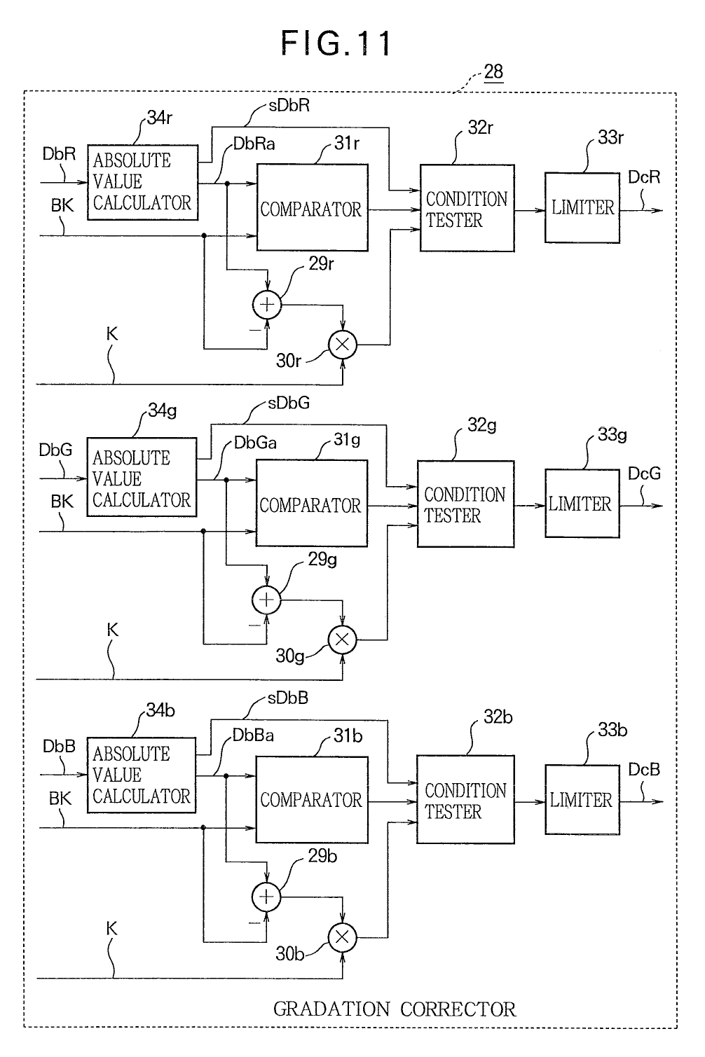

FIG. 11 is a block diagram showing the detailed structure of the gradation corrector 28. The gradation corrector 28 comprises absolute value calculators 34r, 34g, 34b, subtractors 29r, 29g, 29b, multipliers 30r, 30g, 30b, comparators 31r, 31g, 31b, condition testers 32r, 32g, 32b, and limiters 33r, 33g, 33b.

The color signals DbR, DbG, DbB in the image signal Db output from the receiver 2 are input to the absolute value calculators 34r, 34g, 34b, respectively. The absolute value calculators 34r, 34g, 34b output sign signals sDbR, sDbG, sDbB according to the signs of the color signals DbR, DbG, DbB to the condition testers 32r, 32g, 32b, respectively, calculate the absolute values of the color signals DbR, DbG, DbB, and output the results as absolute value signals DbRa, DbGa, DbBa to the comparators 31r, 31g, 31b, and also to the subtractors 29r, 29g, 29b.

The parameter BK calculated in the correction controller 27 is input to the comparators 31r, 31g, 31b and the subtractors 29r, 29g, 29b. The parameter K calculated in the correction controller 27 is input to the multipliers 30r, 30g, 30b.

Subtractor 29r subtracts the parameter BK from the gradation value of the absolute value signal DbRa for the data of each pixel and outputs the resulting difference to multiplier 30r. Similarly, subtractor 29g subtracts the parameter BK from the gradation value of the absolute value signal DbGa for the data of each pixel and outputs the resulting difference to multiplier 30g, and subtractor 29b subtracts the parameter BK from the gradation value of the absolute value signal DbBa for the data of each pixel and outputs the resulting difference to multiplier 30b.

Multiplier 30r multiplies the difference obtained in subtractor 29r by the parameter K and outputs the result to condition tester 32r. Similarly, multiplier 30g multiplies the difference obtained in subtractor 29g by the parameter K and outputs the result to condition tester 32g, and multiplier 30b multiplies the difference obtained in subtractor 29b by parameter the K and outputs the result to condition tester 32b.

Comparator 31r compares the gradation value of the DbRa absolute value signal with the parameter BK for the data of each pixel and outputs the result to condition tester 32r. Similarly, comparator 31g compares the gradation value of the DbGa absolute value signal with the parameter BK for the data of each pixel and outputs the result to condition tester 32g; comparator 31b compares the gradation value of the DbBa absolute value signal with the parameter BK for the data of each pixel and outputs the result to condition tester 32b.

If comparator 31r determines that the gradation value of the absolute value signal DbRa is greater than parameter BK, condition tester 32r selects the product calculated by multiplier 30r; otherwise, condition tester 32r selects ‘0’; if the sign signal sDbR is positive, condition tester 32r outputs the selected value as is to limiter 33r; if the sign signal sDbR is negative, condition tester 32r converts the selected value to a negative value and outputs it to limiter 33r. Similarly, if comparator 31g determines that the gradation value of the absolute value signal DbGa is greater than parameter BK, condition tester 32g selects the product calculated by multiplier 30g; otherwise, condition tester 32g selects ‘0’; if the sign signal sDbG is positive, condition tester 32g outputs the selected value as is to limiter 33g; if the sign signal sDbG is negative, condition tester 32g converts the selected value to a negative value and outputs it to limiter 33g. If comparator 31b determines that the gradation value of the absolute value signal DbBa is greater than parameter BK, condition tester 32b selects the product calculated by multiplier 30b; otherwise, condition tester 32b selects ‘0’; if the sign signal sDbB is positive, condition tester 32b outputs the selected value as is to limiter 33b; if the sign signal sDbB is negative, condition tester 32b converts the selected value to a negative value and outputs it to limiter 33b.

If the input value exceeds the specifiable range of gradation values (from CLIM1 to CLIM2 in FIG. 10, likewise below), limiter 33r limits the value to the specifiable range and outputs the limited value as the DcR color signal. Similarly, if the input value exceeds the specifiable range of gradation values, limiter 33g limits the value to the specifiable range and outputs the limited value as the DcG color signal; if the input value exceeds the specifiable range of gradation values, limiter 33b limits the value to the specifiable range and outputs the limited value as the DcB color signal.

The color signals DbR, DbG, DbB output from limiters 33r, 33g, 33b after gradation-scale correction, that is, the color signals DcR, DcG, DcB, are input to display unit 6.

Let the gradation value of each color signal before gradation-scale correction be A0 and the gradation value after gradation-scale correction be A1. The gradation corrector 28 according to the second embodiment sets A1 as follows:

if (absolute value of A0)≦BK, then

A1=0, and if

if (absolute value of A0)>BK, then

A1=(sign of A0)((absolute value of A0)−BK)×K

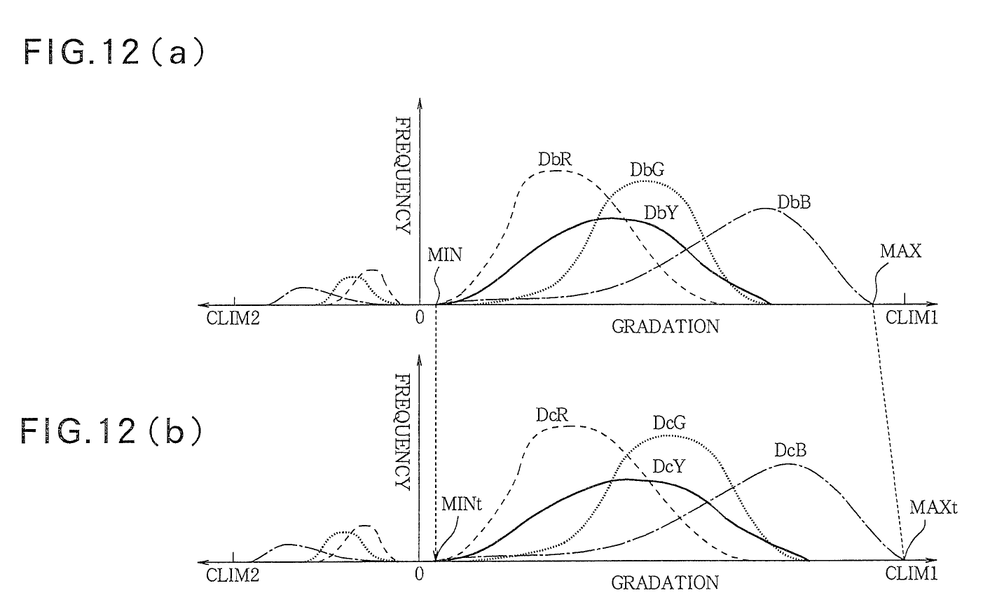

FIG. 12(a) shows the gradation distribution of the color signals DbR, DbG, DbB of the image signal Db for one frame before gradation-scale correction and the gradation distribution of the luminance signal DbY obtained from the image signal Db. FIG. 12(b) shows the gradation distribution of the color signals DcR, DcG, DcB of the image signal Db or image signal Dc after gradation-scale correction and the gradation distribution of the luminance signal DcY obtained from the image signal Dc from the following equation (1′).

DcY=0.30×DcR+0.59×DcG+0.11×DcB (1′)

As with equation (1), the luminance signal DcY may be calculated by using a different equation depending on the format of the input signal. For simplicity, a simpler equation may be used.

In the examples shown in FIGS. 12(a) and 12(b), the maximum gradation value of the blue (B) color signal DbB is the greatest among the maximum gradation values of the color signals DbR, DbG, DbB before gradation-scale correction, which is the maximum color-signal gradation information value MAX. The target value MAXt is CLIM1. The minimum color-signal gradation information value MIN and the target value MINt have the same value.

The parameters Pa calculated from the color information values Ci detected in the positive color signal are used to perform gradation corrections point-symmetrically on both positive and negative color signals as shown in FIG. 10, whereby the size of the circuit can be kept small while the same effects can be obtained on negative color signals as on positive color signals.

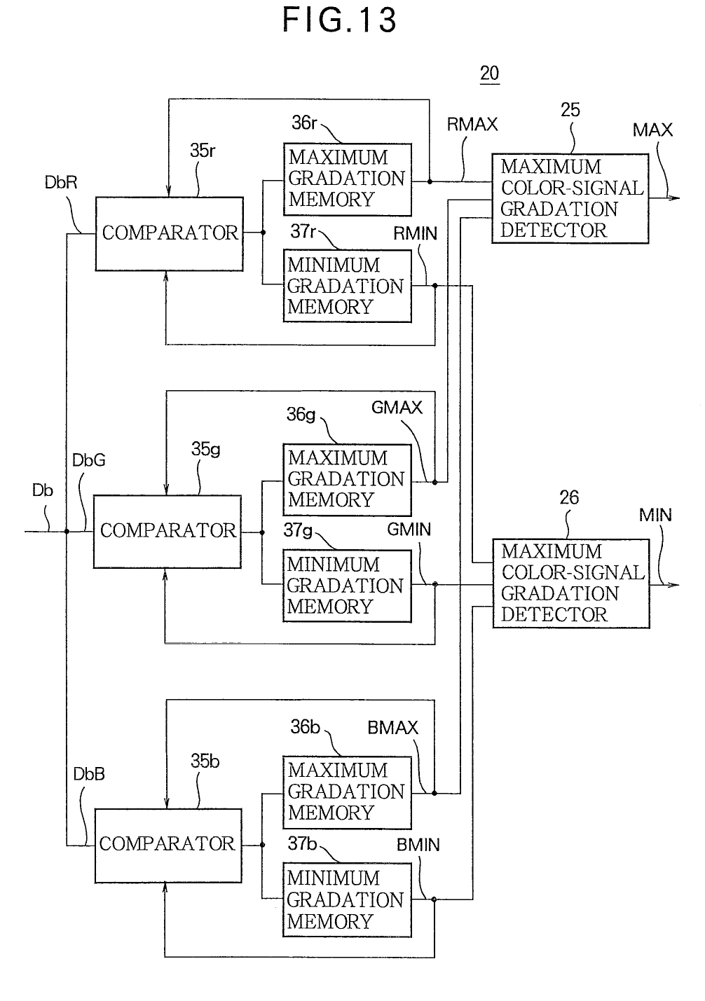

The color information detector 20 according to the second embodiment may have the structure shown in FIG. 13 instead of the structure shown in FIG. 8. The color information detector 20 comprises comparators 35r, 35g, 35b, maximum gradation memories 36r, 36g, 36b, and minimum gradation memories 37r, 37g, 37b as well as the maximum color-signal gradation detector 25 and the minimum color-signal gradation detector 26 that were described above.

The color signals DbR, DbG, DbB in the image signal Db output from the receiver 2 are input to the comparators 35r, 35g, 35b, respectively. Comparator 31r compares the gradation value of the color signal DbR with the maximum gradation information value RMAX stored in maximum gradation memory 36r for the data of each pixel, and if the gradation value of the color signal DbR is greater than the maximum gradation information value RMAX, it outputs the gradation value to maximum gradation memory 36r; otherwise, it does not output any value. Maximum gradation memory 36r stores the gradation value of the color signal DbR output from comparator 35r and updates the maximum gradation information value RMAX to the new maximum gradation information value RMAX. When comparator 35r completes the processing of the color signal DbR for one frame, maximum gradation memory 36r immediately outputs the stored maximum gradation information value RMAX to the maximum color-signal gradation detector 25, resets the maximum gradation information value RMAX, and then proceeds similarly. Accordingly, in this embodiment, the maximum gradation information value RMAX used in the maximum color-signal gradation detector 25 is the maximum gradation value of the color signal DbR for one frame.

Comparator 35r compares the gradation value of the color signal DbR with the minimum gradation information value RMIN stored in minimum gradation memory 37r for the data of each pixel, and if the gradation value of the color signal DbR is smaller than the minimum gradation information value RMIN, comparator 35r outputs the gradation value to minimum gradation memory 37r; if the gradation value is equal to or greater than the minimum gradation information value RMIN, comparator 35r does not output any value. Minimum gradation memory 37r stores the gradation value output from comparator 35r as a new minimum gradation information value RMIN, thereby updating the minimum gradation information value RMIN. When comparator 35r completes the processing of the color signal DbR for one frame, minimum gradation memory 37r immediately outputs the stored minimum gradation information value RMIN to the minimum color-signal gradation detector 26, resets the minimum gradation information value RMIN, and then proceeds similarly. Accordingly, in this embodiment, the minimum gradation information value RMIN used in the minimum color-signal gradation detector 26 is the minimum gradation value of the color signal DbR for one frame.

The color signals DbG and DbB are processed in the same way as the color signal DbR. Comparator 35g, like comparator 35r, compares the gradation value of the color signal DbG with the maximum gradation information value GMAX and outputs the gradation value of the color signal DbG to maximum gradation memory 36g depending on the comparison result. Comparator 35g, like comparator 35r, also compares the gradation value of the color signal DbG with the minimum gradation information value GMIN and outputs the gradation value of the color signal DbG to minimum gradation memory 37g depending on the comparison result. Maximum gradation memory 36g and minimum gradation memory 37g store the input gradation value of the color signal DbG as the latest maximum gradation information value GMAX and the latest minimum gradation information value GMIN, respectively, and when comparator 35g completes the processing of the color signal DbG for one frame, maximum gradation memory 36g and minimum gradation memory 37g immediately output their stored maximum gradation information value GMAX and minimum gradation information value GMIN to the maximum color-signal gradation detector 25 and minimum color-signal gradation detector 26.

Similarly, comparator 35b compares the gradation value of the color signal DbB with the maximum gradation information value BMAX and outputs the gradation value of the color signal DbB to maximum gradation memory 36b depending on the comparison result. Comparator 35b also compares the gradation value of the color signal DbB with the minimum gradation information value BMIN and outputs the gradation value of the color signal DbB to minimum gradation memory 37b depending on the comparison result. Maximum gradation memory 36b and minimum gradation memory 37b store the input gradation value of the color signal DbB as the latest maximum gradation information value BMAX and the latest minimum gradation information value BMIN, respectively, and when comparator 35b completes the processing of the color signal DbB for one frame, maximum gradation memory 36b and minimum gradation memory 37b immediately output their stored maximum gradation information value BMAX and minimum gradation information value BMIN to maximum color-signal gradation detector 25 and minimum color-signal gradation detector 26.

Maximum color-signal gradation detector 25, as described above, outputs the greatest value among the maximum gradation information values RMAX, GMAX, BMAX as the maximum color-signal gradation information value MAX; minimum color-signal gradation detector 26 outputs the smallest value among the minimum gradation information values RMIN, GMIN, BMIN as the minimum color-signal gradation information value MIN. In this embodiment, the maximum color-signal gradation information value MAX is the greatest gradation value of the color signals DbR, DbG, DbB for one frame; the minimum color-signal gradation information value MIN is the smallest gradation value of the color signals DbR, DbG, DbB for one frame.

When the maximum gradation value of the color signals DbR, DbG, DbB for one frame is used as the maximum color-signal gradation information value MAX and the minimum gradation value of the color signals DbR, DbG, DbB for one frame is used as the minimum gradation information value MIN as described above, if the color information detector 20 is configured as shown in FIG. 13, histograms of the gradation values of the color signals DbR, DbG, DbB need not be generated, which makes the configuration of the color information detector 20 simpler.

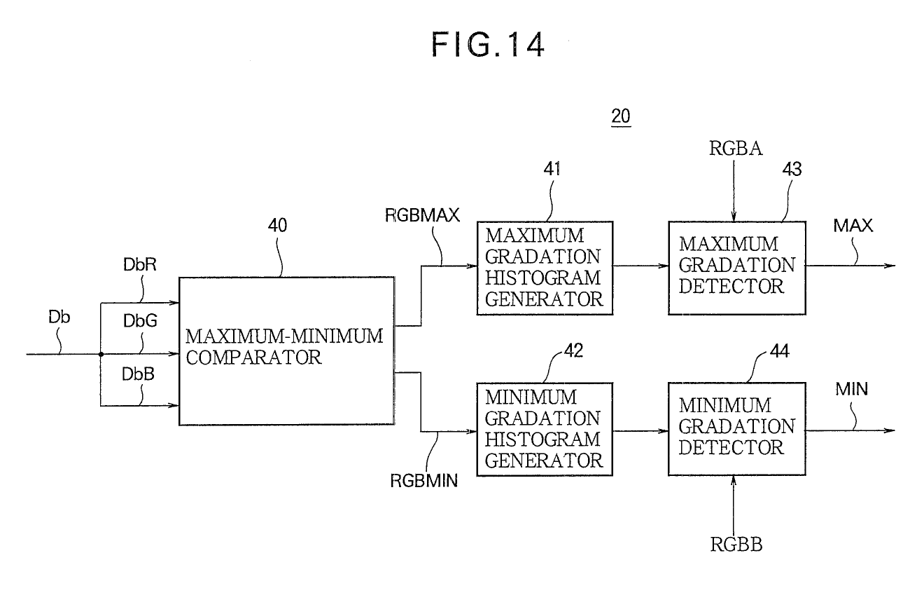

FIG. 14 is a block diagram showing another possible structure of the color information detector 20. The color information detector 20 shown in FIG. 14 comprises a maximum-minimum comparator 40, a maximum gradation histogram generator 41, a minimum gradation histogram generator 42, a maximum gradation detector 43, and a minimum gradation detector 44.

The color signals DbR, DbG, DbB contained in the image signal Db output from the receiver 2 are all input to the maximum-minimum comparator 40. For each pixel, the maximum-minimum comparator 40 extracts the largest of the gradation values of the input color signals DbR, DbG, DbB and outputs the extracted value to the maximum gradation histogram generator 41 as a maximum gradation value RGBMAX. For each pixel, the maximum-minimum comparator 40 also extracts the smallest of the gradation values of the input color signals DbR, DbG, DbB and outputs the extracted value to the minimum gradation histogram generator 42 as a minimum gradation value RGBMIN.

On reception of the maximum gradation values RGBMAX for one frame, the maximum gradation histogram generator 41 counts occurrences of each gradation value as the maximum gradation value RGBMAX and generates a histogram in which each class consists of one gradation value. On reception of the minimum gradation values RGBMIN for one frame, the minimum gradation histogram generator 41 counts occurrences of each gradation value as the minimum gradation value RGBMIN and generates a histogram in which each class consists of one gradation value.

The maximum gradation detector 43 accumulates the frequencies from the maximum gradation to the minimum gradation in the histogram generated by the maximum gradation histogram generator 41, as was done in the maximum gradation detectors 23r, 23g, 23b shown in FIG. 8, and detects a value representing the class at which the resulting accumulated count first exceeds a predetermined threshold value RGBA; in effect, the gradation values constituting the class are detected. The maximum gradation detector 43 outputs the detected representative value as the maximum color-signal gradation information value MAX.

The minimum gradation detector 44 accumulates the frequencies from the minimum gradation to the maximum gradation in the histogram generated by the minimum gradation histogram generator 42, as was done in the minimum gradation detectors 24r, 24g, 24b shown in FIG. 8, and detects a value representing the class at which the resulting accumulated count first exceeds a predetermined threshold value RGBB; in effect, the gradation values constituting the class are detected. The minimum gradation detector 44 outputs the detected representative value as the minimum color-signal gradation information value MIN.

The maximum color signal gradation information value MAX in this example is equivalent to the maximum gradation value in the color signals DbR, DbG, DbB for one frame, and the minimum color signal gradation information value MIN in this example is equivalent to the minimum gradation value in the color signals DbR, DbG, DbB for one frame.

Structuring the color information detector 20 in this way eliminates the need to generate a histogram for each color signal to detect the maximum gradation information value and the minimum gradation information value, so the structure is simpler than the structure shown in FIG. 8.

In addition, values representing the class at which an accumulated count obtained from the gradation histogram first exceeds a threshold value are used as the maximum color signal gradation information value MAX and the minimum color signal gradation information value MIN, so the gradation-scale correction can be adjusted by adjusting the threshold value, and is therefore more finely adjustable than in the structure shown in FIG. 13.

The maximum gradation histogram generator 41 and the minimum gradation histogram generator 42 may generate a histogram by partitioning the gradations into multiple regions and forming each class from a plurality of gradation values. This allows the amount of computation to be reduced.

The maximum gradation histogram generator 41 and the minimum gradation histogram generator 42 may also be structured so that their range of processing, that is, the range over which they count gradation values, can be set arbitrarily. If the number of gradations is ‘256’, the range of processing by the maximum gradation histogram generator 41 may be the range of gradation values from ‘192’to ‘255’, for example, and this range may be divided into eight classes. The range of the processing by the minimum gradation histogram generator 42 may be the range of gradation values from ‘0’to ‘63’, for example, and this range may also be divided into eight classes. The amount of computation can thereby be reduced.

In the image processing apparatus according to the second embodiment, a gradation-scale correction is performed on the image signal Db including negative color signals based on the maximum gradation value of a plurality of color signals or a value equivalent to the maximum gradation value and the minimum gradation value of the plurality of color signals or a value equivalent to the minimum gradation value, so that contrast can also be improved without excessive color collapse in each color signal of an image signal including negative color signals.

### Third Embodiment

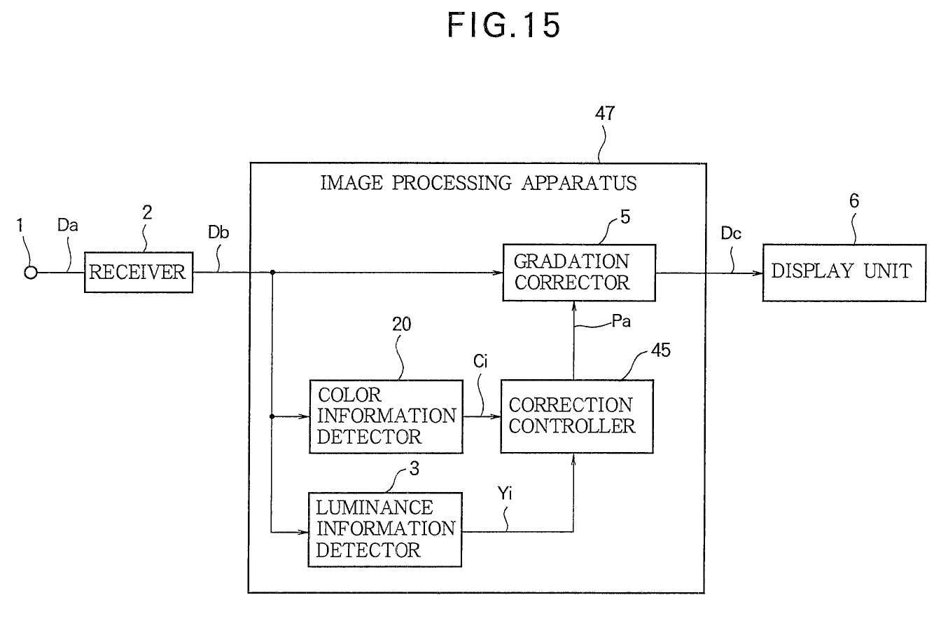

FIG. 15 is a block diagram showing the structure of an image display apparatus according to a third embodiment of the invention. The image display apparatus according to the third embodiment has an image processing apparatus 47 instead of the image processing apparatus 7 in the image processing apparatus according to the first embodiment described above.

The image processing apparatus 47 according to the third embodiment comprises the luminance information detector 3 and the gradation corrector 5 according to the first embodiment, the color information detector 20 according to the second embodiment, and a correction controller 45. The luminance information detector 3 calculates luminance signal values DbY from the color signals included in the image signal Db output from the receiver 2, detects luminance information values Yi from the calculated luminance signal values DbY for each pixel, and outputs the detected values.

The correction controller 45 calculates correction parameters Pa used by the gradation corrector 5 in performing gradation-scale corrections on the image signal Db from the color information values Ci output from the color information detector 20 and the luminance information values Yi output from the luminance information detector 3, and outputs them to the gradation corrector 5. The gradation corrector 5 uses the input correction parameters Pa to perform a gradation-scale correction on the image signal Db, which it then outputs as an image signal Dc to the display unit 6. The display unit 6 displays the image based on the input image signal Dc.

The luminance information detector 3 performs exactly the same operations as described in the first embodiment, so a detailed description will be omitted.

The color information detector 20 performs substantially the same operations as described in the second embodiment. Operations differing from the operations in the second embodiment will be explained below.

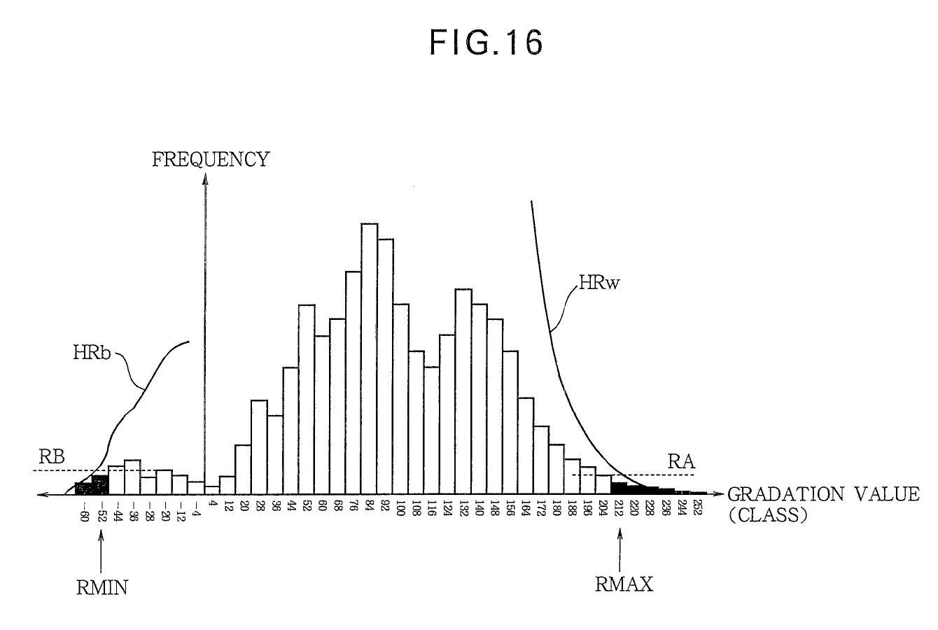

FIG. 16 shows an exemplary histogram generated by the histogram generator 22r. The symbols and numbers shown in this diagram are similar to those in FIG. 9. A difference from FIG. 9 is that negative values are also included in the minimum gradation detection range. This is because even if the color information detector 20 is exactly the same as described in the second embodiment, the minimum gradation to be detected differs depending on the method of representing negative numbers in the digital image signal Db. Methods of representing negative numbers will be described below.

Methods of representing negative numbers in the digital image signal Db will now be described. An eight-bit digital signal, for example, has 256 gradations, from 0 to 255. To represent negative numbers, it is possible to add one sign bit to these eight bits, for example, and obtain a digital signal with a total of nine bits, thereby representing values from −256 to 255. Other methods of representing negative numbers include the use of one's compliments, two's compliments, and offsets; with two's compliments, for example, ‘100000000’ represents −256, ‘000000000’ represents 0, and ‘011111111’ represents 255. In the 256-offset representation, ‘000000000’ represents −256, ‘100000000’ represents 0, and ‘111111111’ represents 255.

If negative numbers are represented by the offset method and the color information detector 20 detects the minimum gradation on the assumption that the offsets represent only positive numbers, negative numbers are included in the detection range.

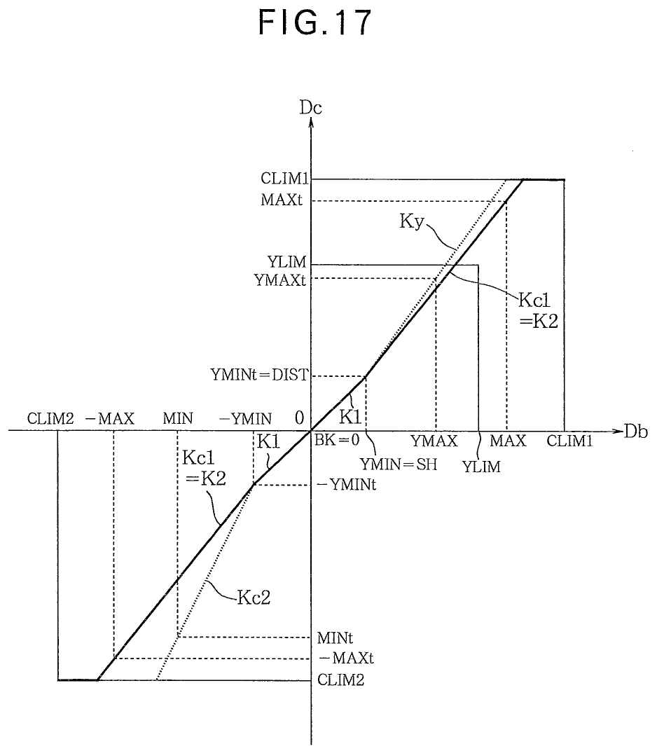

The correction controller 45 calculates correction parameters Pa based on the input color signal information values Ci and the luminance information value Yi and outputs the result to the gradation corrector 5. FIG. 17 is a graph illustrating the operation of the correction controller 45. In the x-y coordinate system in FIG. 17, in which both the horizontal axis (x-axis) and the vertical axis (y-axis) indicate gradation values, the luminance signal minimum gradation information value YMIN in the luminance information value Yi, and the minimum color-signal gradation information value MIN and the maximum color-signal gradation information value MAX in the color information values Ci are indicated on the x-axis; the target value YMINt when gradation corrections are performed with the luminance signal minimum gradation information value YMIN and the target values MINt and MAXt when gradation corrections are performed with the minimum color-signal gradation information value MIN and the maximum color-signal gradation information value MAX are indicated on the y-axis.

The correction controller 45 sets K2 to the smallest of the slope Ky of a straight line drawn connecting x-y coordinates (YMIN, YMINt) and x-y coordinates (YMAX, YMAXt), the slope Kc1 of a straight line drawn connecting x-y coordinates (YMIN, YMINt) and x-y coordinates (MAX, MAXt), and the slope Kc2 of a straight line drawn connecting x-y coordinates (−YMIN, −YMINt) and x-y coordinates (MIN, MINt), sets BK to zero (BK=0), and sets K1 to the slope of a straight line drawn connecting x-y coordinates (YMIN, YMINt) and x-y coordinates (0, 0). By setting K2 to the smallest of Ky, Kc1, and Kc2 as described above, and controlling gradation-scale corrections in the negative region so that they are performed point-symmetrically with respect to the origin, color collapse, white collapse, and black collapse can be suppressed.

If gradation-scale corrections are performed on positive and negative color signals with different parameters, then when a pixel includes both positive and negative color signals, the degree of gradation correction differs depending on the color signal, causing the hue of the pixel to change, but if the gradation-scale corrections in the negative region are controlled so that they are performed point-symmetrically with respect to the origin, unintended hue changes can be suppressed.

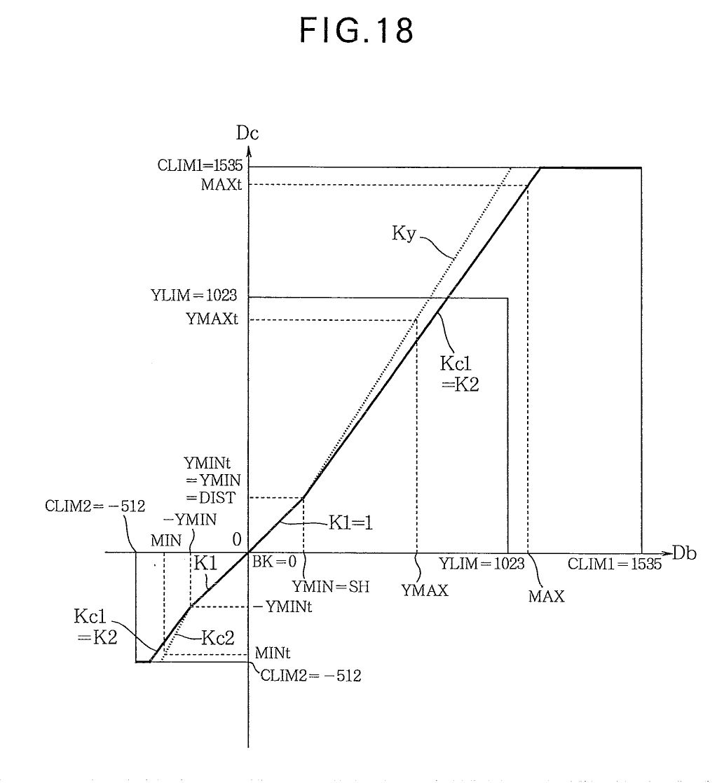

A more specific example will be described with reference to FIG. 18. The upper limit value CLIM1 of each of the color signals R, G, B is 1535, the lower limit value CLIM2 is −512, and the upper limit value of the luminance Y is 1023. The values of YMAXt, MAXt, and MINt are calculated from the luminance signal maximum gradation information value YMAX and the luminance signal minimum gradation information value YMIN detected by the luminance information detector 3 and the maximum color-signal gradation information value MAX and the minimum color-signal gradation information value MIN detected by the color information detector 20 using the following equations (16), (17), and (18).

YMAXt=YMAX+(YMAX−YMIN)×KYmax (16)

MAXt=MAX+(MAX−YMIN)×Kmax (17)

MINt=MIN−(MAX+YMIN)×Kmin (18)

To satisfy the conditions YMAXt ≦YMIN, MAXt ≦CLIM1, and MINt ≧CLIM2 and leave a little margin, YMAXt is set to a value a little smaller than YLIM, MAXt to a value a little smaller than CLIM1, and MINt to a value a little larger than CLIM2 (because it is a negative number).

From these calculated values of YMAXt, MAXt, and MINt, the values of Ky, Kc1, and Kc2 are obtained in the way described above, and the smallest value Kc1 (the smallest slope) is used as K2.

When MIN is equal to or greater than YMIN (MIN ≧ YMIN), however, MINt is not set, and Kc1 is not used.

If YMINt is set to a value equal to the luminance signal minimum gradation information value YMIN, then K1 is 1 (K1=1), and no gradation-scale corrections are performed in low gradation areas (dark areas) with gradation values less than the luminance signal minimum gradation information value YMIN. Since the human eye is highly sensitive to dark gradations and gradation-scale corrections performed on dark areas might degrade the image quality instead of improving it, this method, in which YMINt is set to a value equal to the luminance signal minimum gradation information value YMIN and K1 is set to 1 (K1=1), may be used.

When the parameters Pa, that is, BK, SH, DIST, K1, and K2, are determined, the gradation corrector 5 corrects the gradation values of the image signal Db as described in the first embodiment and outputs the image data DcR after the gradation corrections to the display unit 6.

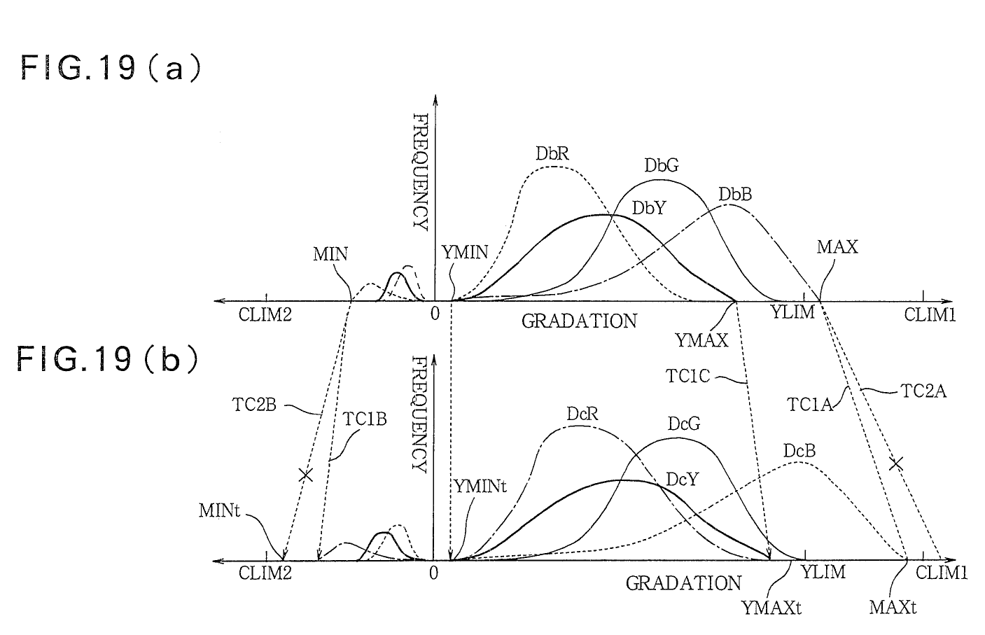

FIG. 19(a) shows the gradation distribution of the color signals DbR, DbG, DbB of the image signal Db for one frame before gradation-scale correction and the gradation distribution of the luminance signal DbY obtained from the image signal Db. FIG. 19(b) shows the gradation distribution of the color signals DcR, DcG, DcB of the image signal Db or image signal Dc after gradation-scale correction and the gradation distribution of the luminance signal DcY obtained from the image signal Dc.

In the examples shown in FIGS. 19(a) and 19(b), the maximum gradation value of the blue (B) color signal DbB is the greatest among the maximum gradation values of the color signals DbR, DbG, DbB before gradation-scale correction, which is the maximum color-signal gradation information value MAX. The target value MAXt is a value a little smaller than CLIM1. The minimum gradation value of the blue (B) color signal DbB is the smallest among the minimum gradation values of the color signals DbR, DbG, DbB before gradation-scale correction, which is the minimum color-signal gradation information value MIN. The target value MINt is a value a little larger than CLIM2. The target value YMAXt of the luminance signal maximum gradation information value YMAX is a little smaller than YLIM; the target value YMINt of the luminance signal minimum gradation information value YMIN is the same as the luminance signal minimum gradation information value YMIN.

As described above, Ky, Kc1, and Kc2 are obtained from YMAXt, MAXt, and MINt and K2 is set to the smallest of these parameter values, namely Kc1. The gradation corrections in this case are as indicated by dotted lines TC1A, TC1B, and TC1C. The graph shows that K2 set to Kc1 causes the color signals DcR, DcG, and DcB after gradation correction not to exceed their upper limit value CLIM1 and lower limit value CLIM2 (not to take values greater than the upper limit value CLIM1 or values smaller than the lower limit value CLIM2) and the luminance signal DcY obtained from the color signals DcR, DcG, DcB not to exceed the luminance upper limit value YLIM.

Gradation corrections with K2 set to Kc2 are indicated by dotted lines TC2A and TC2B. As shown in the graph, among the color signals DcR, DcG, DcB of the image signal Dc, which is the image signal Db after the gradation correction, color signal DcB exceeds the upper limit value CLIM1 of the color signals at the right end in FIGS. 19(a) and 19(b), so color collapse occurs.

As described above, the image processing apparatus of the third embodiment performs gradation corrections of an image signal including negative color signals based on the maximum gradation value of the luminance signal or a value equivalent to the maximum gradation value, the minimum gradation value of the luminance signal or a value equivalent to the minimum gradation value, the maximum gradation value of a plurality of color signals or a value equivalent to the maximum gradation value, and the minimum gradation value of a plurality of color signals or a value equivalent to the minimum gradation value, thereby improving contrast of an image signal including negative color signals while suppressing color collapse in each color signal.

### Fourth Embodiment

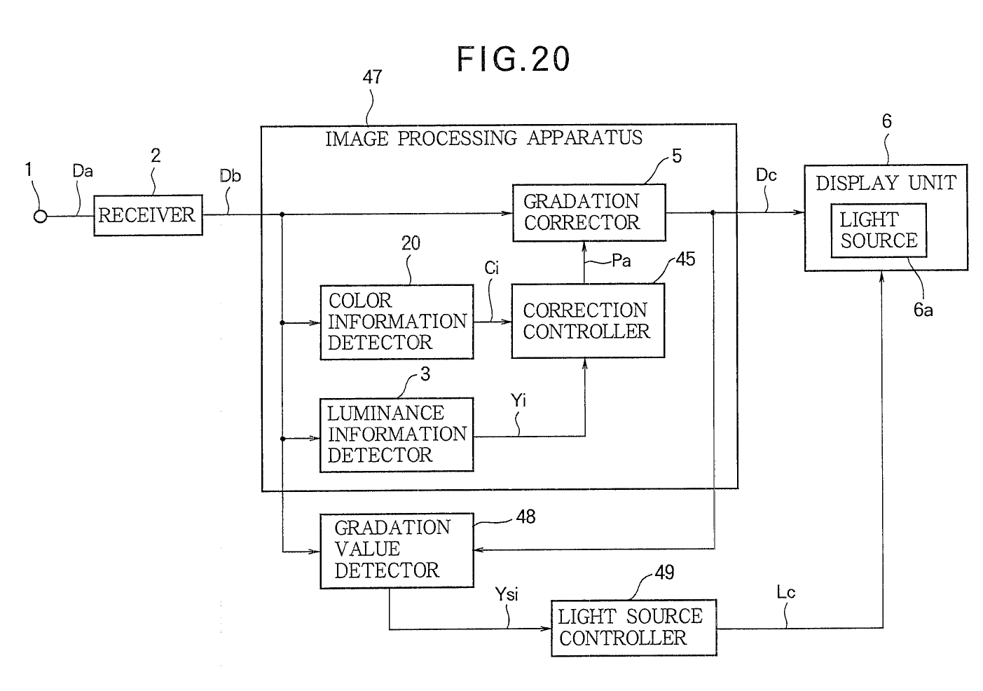

FIG. 20 is a block diagram showing the structure of an image display apparatus according to a fourth embodiment of the invention. The image display apparatus according to the fourth embodiment further comprises a gradation value detector 48 and a light source controller 49 in the image display apparatus according to the third embodiment described above. The display unit according to the fourth embodiment has a light source 6a and displays an image by modulating the light emitted from the light source 6a based on the image signal Dc. The display unit 6 is, for example, a liquid crystal display unit or a projector using a liquid crystal panel or a DMD as a light valve.

The gradation value detector 48 receives the image signal Db output from the receiver 2 and the image signal Dc output from the gradation corrector 5. The gradation value detector 48 detects an average gradation value Ybav of the luminance signal DbY obtained from one frame of the image signal Db and an average gradation value Ycav of the luminance signal DcY obtained from the corresponding frame of the image signal Dc. The gradation value detector 48 subtracts the average gradation value Ycav from the average gradation value Ybav and outputs the difference as luminance change information Ysi to the light source controller 49. The light source controller 49 generates a light source control signal Lc in accordance with the input luminance change information value Ysi and outputs this signal to the display unit 6. The display unit 6 determines the brightness of the light source 6a in accordance with the input light source control signal Lc. The other components are the same as in the image display apparatus according to the third embodiment, so descriptions will be omitted.

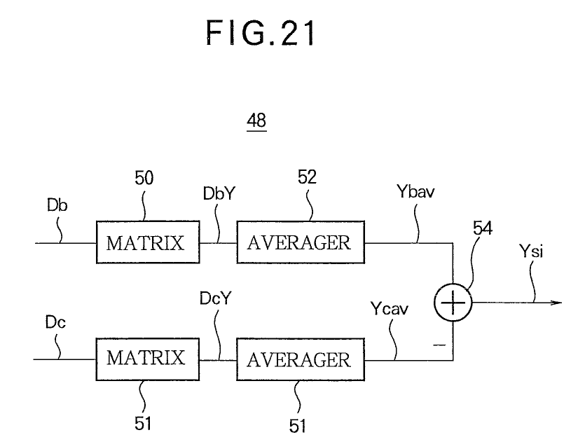

FIG. 21 is a block diagram showing the detailed structure of the gradation value detector 48. As shown in FIG. 21, the gradation value detector 13 comprises matrix circuits 50, 51, averagers 52, 53, and a subtractor 54.

The matrix circuit 50 outputs the luminance signal DbY derived from the image signal Db, using the above equation (1). Matrix circuit 51 outputs the luminance signal DcY derived from the image signal Dc, using the above equation (1′).

Depending on the type of image signals Db, Dc, a different equation may be used to derive the luminance signals DbY, DcY, or a simpler formula may be used to simplify the calculations, but both matrix circuits 50, 51 should derive the luminance signals DbY, DcY by the same formula.

The averager 52 derives the average gradation value Ybav of the luminance signal DbY for one frame by summing up the gradation values of the luminance signal DbY for one frame and dividing the sum by the number of pixels in one frame, and outputs the result to the subtractor 54. The averager 53 derives the average gradation value Ycav of the luminance signal DcY for one frame by summing up the gradation values of the luminance signal DcY for one frame and dividing the sum by the number of pixels in one frame, and outputs the result to the subtractor 54.

The subtractor 54 uses the following equation (19) to derive the luminance change information value Ysi and outputs the result to the light source controller 49.

Ysi=Ybav−Ycav (19)

The light source controller 49 outputs the light source control signal Lc generated by using the following equation (20), and the display unit 6 uses this signal to determine the brightness of the light source 6a.

Lc=ORG+Ysi×Ksc (20)

The display unit 6 increases the brightness of the light source 6a as the value of the light source control signal Lc increases, and decreases the brightness of the light source 6a as the value decreases.

In equation (20), ORG indicates a value determined in accordance with the brightness of the light source 6a to be set when the luminance change information value Ysi is 0, i.e., when the same average luminance is maintained before and after the gradation-scale correction. The quantity Ksc in equation (20) is a light source control coefficient. Larger values of Ksc produce larger changes in the brightness of the light source 6a.

As indicated by equations (19) and (20), in the image display apparatus according to the fourth embodiment, an increase in the value of the luminance change information Ysi in the positive direction increases the light source control signal Lc, increasing the brightness of the light source 6a in the display unit 6. On the other hand, an increase in the value of the luminance change information Ysi in the negative direction decreases the light source control signal Lc, decreasing the brightness of the light source 6a in the display unit 6.

That is, if the operation of the light source controller 49 increases the luminance change information value Ysi in the negative direction, that is, if the average gradation value after the gradation-scale correction of the image signal Db is greater than the corresponding value before the gradation-scale correction, the brightness of the light source 6a decreases.

In general, leakage of light from the light source 6a is perceived easily by the viewer (as brightness) in low-luminance areas on the screen of the display unit 6. One effective way to prevent this is to reduce the brightness of the light source 6a, but simply reducing the brightness of the light source 6a would decrease the brightness of high-luminance areas on the screen.

The image display apparatus according to the fourth embodiment is controlled so that if the average gradation value after the gradation-scale correction of the image signal Db is greater than the corresponding value before the gradation-scale correction, the brightness of the light source 6a is reduced; consequently, while the brightness in high-luminance areas on the screen of the display unit 6 is enhanced, the brightness of the light source 6a can be reduced so that the viewer does not perceive the brightness of the light source 6a in low-luminance areas.

Light source control according to the fourth embodiment has been described on the basis of the image display apparatus according to the third embodiment. The light source control technique according to the fourth embodiment can be applied to the image display apparatus according to the first embodiment and the image display according to the second embodiment by adding a gradation value detector 48 and a light source controller 49, and the same effects can be obtained.

The gradation value detector 13 according to the fourth embodiment detects the average gradation values Ybav, Ycav and outputs the difference between them as the luminance change information value Ysi, but the sum of the gradation values of the luminance signal DbY obtained from image signal Db for one frame and the sum of the gradation values of the luminance signal DcY obtained from image signal Dc for one frame may be detected, and the difference between them may be output to the light source controller 49 as the luminance change information value Ysi. In that case, averager 52 sums up the gradation values of the luminance signal DbY for one frame and outputs the sum directly to the subtractor 54 without dividing it by the number of pixels in one frame. Averager 53 sums up the gradation values of the luminance signal DcY for one frame and outputs the sum directly to the subtractor 54 without dividing it by the number of pixels in one frame. The subtractor 54 subtracts the sum of the gradation values of the luminance signal DcY for one frame from the sum of the gradation values of the luminance signal DbY for one frame and outputs the resulting difference as the luminance change information value Ysi to the light source controller 49. The light source controller 49 and the display unit 6 operate in the same way as described above.

If the difference obtained by subtracting the sum of the gradation values of the luminance signal DbY obtained from one frame of the image signal Db after the gradation-scale correction from the sum of the values before the gradation-scale correction is used as the luminance change information value Ysi, when the sum of the gradation values of the luminance signal DbY obtained from one frame of the image signal Db after the gradation-scale correction is greater than the sum before the gradation-scale correction, the brightness of the light source 6a is decreased. In that case, the same effects as described above can be obtained, and while brightness in high-luminance areas on the screen of the display unit 6 is enhanced, the brightness of the light source 6a can be reduced so that the viewer does not easily perceive the brightness of the light source 6a in low-luminance areas. In addition, the structures of the averagers 52, 53 can be simplified because they do not need to perform division.

What is claimed is:

1. An image processing apparatus for performing image processing on an input image signal including a plurality of color signals, comprising:
a luminance information detector for detecting, from a luminance signal obtained from the input image signal, for each frame, a maximum luminance signal gradation information value, the maximum luminance signal gradation value being a maximum gradation value or a value equivalent to the maximum gradation value, and a minimum luminance signal gradation information value, the minimum luminance signal gradation information value being minimum gradation value or a value equivalent to the minimum gradation value, and outputting the detected values as luminance information values;
a correction controller for calculating a correction parameter based on the luminance information values; and
a gradation corrector for performing a gradation-scale correction on the plurality of color signals included in the image signal based on the correction parameter; wherein
the plurality of color signals may take negative values.

2. An image display apparatus comprising;
the image processing apparatus in claim 1; and
a display unit for displaying an image based on a post-gradation-scale-correction image signal obtained from the input image signal by the image processing apparatus by performing the gradation-scale correction.

3. The image display apparatus in claim 2, wherein the display unit has a light source with a controllable brightness, and displays the image by modulating light emitted from the light source based on the post-gradation-scale-correction image signal.

4. The image display apparatus in claim 3, further comprising:
a gradation value detector for detecting average gradation values of the luminance signal obtained from the input image signal and a luminance signal obtained from the post-gradation-scale-correction image signal, or total sums of gradation values of both luminance signals; and
a light source controller for controlling the brightness of the light source so that the brightness of the light source is reduced when the value detected from the post-gradation-scale-correction image signal exceeds the value detected from the input image signal.

5. An image processing apparatus for performing image processing on an input image signal including a plurality of color signals, comprising:
a color information detector for detecting, for each of the plurality of color signals, for each frame, a maximum color-signal gradation information value, the maximum color-signal gradation information value being a maximum gradation value or a value equivalent to the maximum gradation value, and a minimum color-signal gradation information value, the minimum color-signal gradation information value being a minimum gradation value or a value equivalent to the minimum gradation value, and outputting the detected values as color information values;
a correction controller for calculating a correction parameter based on the color information values; and
a gradation corrector for performing a gradation-scale correction on the plurality of color signals included in the image signal based on the correction parameter; wherein
the plurality of color signals may take negative values.

6. An image display apparatus comprising;
the image processing apparatus in claim 5; and
a display unit for displaying an image based on a post-gradation-scale-correction image signal obtained from the input image signal by the image processing apparatus by performing the gradation-scale correction.

7. The image display apparatus in claim 6, wherein the display unit has a light source with a controllable brightness, and displays the image by modulating light emitted from the light source based on the post-gradation-scale-correction image signal.

8. The image display apparatus in claim 5, further comprising:
a gradation value detector for detecting average gradation values of a luminance signal obtained from the input image signal and a luminance signal obtained from the post-gradation-scale-correction image signal, or total sums of gradation values of both luminance signals; and
a light source controller for controlling the brightness of the light source so that the brightness of the light source is reduced when the value detected from the post-gradation-scale-correction image signal exceeds the value detected from the input image signal.

9. An image processing apparatus for performing image processing on an input image signal including a plurality of color signals, comprising:
a luminance information detector for detecting, from a luminance signal obtained from the input image signal, for each frame, a maximum luminance signal gradation information value, the maximum luminance signal gradation value being a maximum gradation value or a value equivalent to the maximum gradation value, and a minimum luminance signal gradation information value, the minimum luminance signal gradation information value being a minimum gradation value or a value equivalent to the minimum gradation value, and outputting the detected values as luminance information values;
a color information detector for detecting, for each of the plurality of color signals, for each frame, a maximum color-signal gradation information value, the maximum color-signal gradation information value being a maximum gradation value or a value equivalent to the maximum gradation value, and a minimum color-signal gradation information value, the minimum color-signal gradation information value being a minimum gradation value or a value equivalent to the minimum gradation value, and outputting the detected values as color information values;
a correction controller for calculating a correction parameter based on the luminance information values and the color information values; and
a gradation corrector for performing gradation-scale correction on the plurality of color signals included in the image signal based on the correction parameter; wherein
the plurality of color signals may take negative values.

10. An image display apparatus comprising;
the image processing apparatus in claim 9; and
a display unit for displaying an image based on a post-gradation-scale-correction image signal obtained from the input image signal by the image processing apparatus by performing the gradation-scale correction.

11. The image display apparatus in claim 10, wherein the display unit has a light source with a controllable brightness, and displays the image by modulating light emitted from the light source based on the post-gradation-scale-correction image signal.

12. The image display apparatus in claim 11, further comprising:
a gradation value detector for detecting average gradation values of a luminance signal obtained from the input image signal and a luminance signal obtained from the post-gradation-scale-correction image signal, or total sums of gradation values of both luminance signals; and
a light source controller for controlling the brightness of the light source so that the brightness of the light source is reduced when the value detected from the post-gradation-scale-correction image signal exceeds the value detected from the input image signal.
